(19) United States
(12) Patent Application Publication
(10) Pub. No.: US 2025/0298859 A1
(43) Pub. Date: Sep. 25, 2025

(54) QUANTUM SIMULATION OF TIME-DEPENDENT HAMILTONIANS

(71) Applicant: XANADU QUANTUM TECHNOLOGIES INC., Toronto (CA)

(72) Inventors: Pablo Antonio MORENO CASARES, Badajoz (ES); Modjtaba SHOKRIAN ZINI, Toronto (CA)

(21) Appl. No.: 18/610,062

(22) Filed: Mar. 19, 2024

(51) Int. Cl. G06F 17/11; G06N 10/80

(52) U.S. Cl. CPC G06F 17/11; G06N 10/80

(57) ABSTRACT

A method of time-dependent quantum Hamiltonian simulation that is capable of efficiently achieving a target error is described. The time evolution of a time-dependent Hamiltonian describing a physical system is modeled using a Magnus operator that has one or more nested commutators and integrals. The Magnus operator is approximated with a commutator-free operator up to an order n. An error between the commutator-free operator and the Magnus operator as result of the approximation is estimated based at least in part on a simulation step size h. The commutator-free operators may be simulated on a quantum computer via one or more quantum gates for a total simulation time in temporal increments of h, where the step size h has a value such that a simulation error of the simulation is less than or equal to a target error.

### CROSS-REFERENCE TO RELATED APPLICATIONS

This is the first patent application related to the instant technology.

### BACKGROUND OF THE INVENTION

The present disclosure is related to quantum technology, and in particular to the use of quantum computers to simulate properties of time-dependent quantum systems.

Quantum systems are physical systems the behavior of which can be described by quantum mechanical rules. Such systems are generally designed based on their properties and relevance to practical applications such as the simulation of the quantum dynamics of physical systems. As such, they can represent spin models, molecules, materials, or other phases of matter, each of these potentially impossible to realize in experiments.

Such systems can be described in full generality by a potentially time-dependent Hamiltonian operator. This time-dependence is essential for accurately describing systems involving a time-dependent interaction with an environment or external field, which transforms a corresponding fixed Hamiltonian to a time-dependent one. Understanding how some initial state of quantum systems evolve under this time-dependent dynamic is crucial for certain applications, such as obtaining the spectrum of a Hamiltonian, preparing excited states, or computing transition probabilities under the action of an external potential. The goal is to then be able to simulate the time-dependent Hamiltonian on a quantum computer to provide meaningful metrics about the quantum systems.

However, to the best knowledge of the inventors, there has not been any Magnus-based product formula method that could demonstrably and accurately achieve a target simulation error of a time-dependent quantum simulation using an optimal temporal increment. Accordingly, there remains a need for an efficient and practical implementation of the Magnus series expansion method of quantum simulation while allowing the corresponding simulation error to be predicatively achieved.

### SUMMARY OF THE INVENTION

In accordance with a first aspect of the present disclosure, there is provided a method of time-dependent quantum simulation, the method comprising: receiving, at a classical processor, a time-dependent Hamiltonian describing a quantum system, a target error, and a total simulation time T; modeling a time evolution of the Hamiltonian with a Magnus operator based on a time step size h, the target error and total simulation time, the Magnus operator having one or more nested commutators and integrals; approximating the Magnus operator with a commutator-free operator up to an order n; performing error estimation between the commutator-free operator and the Magnus operator as result of the approximation, the error estimation is based at least in part on h; and simulating, on a quantum processor, the dynamics of the quantum system by implementing the commutator-free operator via one or more quantum gates, and applying the one or more quantum gates to an initial state of the quantum system for the total simulation time in temporal increments of h, the step size h having a value such that a simulation error of the simulation is less than or equal to the target error.

In accordance with a second aspect of the present disclosure, there is provided a non-transitory, processor-readable medium storing instructions that, when executed by a processor, cause the processor to: receive, at a classical processor, a time-dependent Hamiltonian describing a quantum system, a target error, and a total simulation time T; model a time evolution of the Hamiltonian with a Magnus operator based on a time step size h, the target error and total simulation time, the Magnus operator having one or more nested commutators and integrals; approximate the Magnus operator with a commutator-free operator up to an order n; perform error estimation between the commutator-free operator and the Magnus operator as result of the approximation, the error estimation is based at least in part on h; and simulate, on a quantum processor, the dynamics of the quantum system by implementing the commutator-free operator via one or more quantum gates, and applying the one or more quantum gates to an initial state of the quantum system for the total simulation time in temporal increments of h, the step size h having a value such that a simulation error of the simulation is less than or equal to the target error.

In any of the above aspects, the modelling may further include: constructing a Magnus operator ansatz; decomposing the time-dependent Hamiltonian into a Taylor series expansion; and substituting the Taylor series expansion into the Magnus operator ansatz to derive the Magnus operator.

In any of the above aspects, the approximating of the Magnus operator may further include: converting the Magnus operator to an intermediate operator comprising a plurality of Lie algebra generators; performing a change of basis on the intermediate operator from the plurality of Lie algebra generators to generate a univariate intermediate operator comprising one or more exponentials of univariate integrals; generating a plurality of quadrature-based exponentials based on the one or more exponentials of univariate integrals by applying a quadrature rule; and approximating the one or more quadrature-based exponentials as a product formula of order n, where the product formula is the commutator-free operator.

In any of the above aspects, the product formula approximating the quadrature-based exponentials may be a Trotter-Suzuki product formula of order n.

In any of the above aspects, the error estimation may include: minimizing a number of simulation steps T/h needed to simulate the time evolution of the Hamiltonian for the total simulation time using the target error as an upper bound of the simulation error.

In any of the above aspects, the error estimation may include determining an error bound for each of a univariate intermediate operator definition error and a quadrature error as a function of h.

In any of the above aspects, the error estimation may include determining an error bound for a product formula conversion error as a function of h.

In any of the above aspects, the determining of the error bound for the univariate intermediate operator definition error may include: determining an error bound for a first series truncation error, the error bound for the first series truncation error including error terms of order higher than n in h, wherein the coefficient at each order includes sums over nested integer compositions, with an outermost term being compositions of the order, and is weighted by a fraction having a numerator that is a power of the upper bound to the norm of (1) the Hamiltonian and (2) coefficients of a Taylor series expansion of the Hamiltonian; and determining an error bound for a second series truncation error, the error bound for the second series truncation error including error terms of order higher than n in h, wherein the coefficient at each order includes sums over weak integer compositions of the order and is weighted by a multinomial of the terms of the weak integer compositions and the upper bound to the norm of (1) the Hamiltonian and (2) the coefficients of the Taylor series expansion.

In any of the above aspects, the determining of the error bound for the quadrature error may include determining a distance between a plurality of quadrature-based exponentials and one or more exponentials of univariate integrals using a quadrature rule.

In any of the above aspects, the Hamiltonian may be a sum of a plurality of self-commuting fast-forwardable Hermitian operators, including a time-independent kinetic operator and a time-dependent potential operator; and the quadrature-based exponentials may be the commutator-free operator.

In any of the above aspects, the quadrature-based exponentials may be approximated by a multi-product formula as a linear combination of powers of the commutator-free operator product formulas with fractions of h as a simulation step size.

In any of the above aspects, the simulation error may include an error bound for a multi-product formula conversion error as a function of h and the coefficients of the linear combination defining the multi-product formula.

In any of the above aspects, the instructions to model the time evolution may include instructions to: construct a Magnus operator ansatz; decompose the time-dependent Hamiltonian into a Taylor series expansion; and substitute the Taylor series expansion into the Magnus operator ansatz to derive the Magnus operator.

In any of the above aspects, the instructions to approximate the Magnus operator may include instructions to: convert the Magnus operator to an intermediate operator comprising a plurality of Lie algebra generators; perform a change of basis on the intermediate operator from the plurality of Lie algebra generators to generate a univariate intermediate operator comprising one or more exponentials of univariate integrals; generate a plurality of quadrature-based exponentials based on the one or more exponentials of univariate integrals by applying a quadrature rule; and approximate the one or more quadrature-based exponentials as a product formula of order n, where the product formula is the commutator-free operator.

In any of the above aspects, the instructions to perform the error estimation may include instructions to: minimize a number of simulation steps T/h needed to simulate the time evolution of the Hamiltonian for the total simulation time using the target error as an upper bound of the simulation error.

In any of the above aspects, the instructions to perform the error estimation may include instructions to determine an error bound for each of a univariate intermediate operator definition error and a quadrature error as a function of h.

In any of the above aspects, the instructions to perform the error estimation may include instructions to determine an error bound for a product formula conversion error as a function of h.

In any of the above aspects, the instructions to determine the error bound for the univariate intermediate operator definition error may include instructions to: determine an error bound for a first series truncation error, the error bound for the first series truncation error including error terms of order higher than n in h, wherein the coefficient at each order includes sums over nested integer compositions, with an outermost term being compositions of the order, and is weighted by a fraction having a numerator that is a power of the upper bound to the norm of (1) the Hamiltonian and (2) coefficients of a Taylor series expansion of the Hamiltonian; and determine an error bound for a second series truncation error, the error bound for the second series truncation error including error terms of order higher than n in h, wherein the coefficient at each order includes sums over weak integer compositions of the order and is weighted by a multinomial of the terms of the weak integer compositions and the upper bound to the norm of (1) the Hamiltonian and (2) the coefficients of the Taylor series expansion.

In any of the above aspects, the instructions to determine the error bound for the quadrature error may include instructions to determine a distance between a plurality of quadrature-based exponentials and one or more exponentials of univariate integrals using a quadrature rule.

In any of the above aspects, the Hamiltonian may be a sum of a plurality of self-commuting fast-forwardable Hermitian operators, including a time-independent kinetic operator and a time-dependent potential operator; and the quadrature-based exponentials may be the commutator-free operator.

In any of the above aspects, the quadrature-based exponentials may be approximated by a multi-product formula as a linear combination of powers of the commutator-free operator product formulas with fractions of h as a simulation step size.

In any of the above aspects, the simulation error may include an error bound for a multi-product formula conversion error as a function of h and the coefficients of the linear combination defining the multi-product formula.

### BRIEF DESCRIPTION OF DRAWINGS

Reference will now be made, by way of example, to the accompanying drawings which show example embodiments of the present disclosure, and in which:

FIG. 1 illustrates a simplified block diagram of an example embodiment of a quantum simulation system in accordance with the present disclosure;

FIG. 2 illustrates a system diagram showing tasks performed by a simulation initialization module and a quantum simulation algorithm module in accordance with some embodiments;

FIG. 3 illustrates a pseudo code for an algorithm for deriving commutator-free quasi-Magnus (CFQM) operators for a given time-dependent Hamiltonian in accordance with one aspect of the present disclosure;

FIG. 4 illustrates a flowchart of the conversions and basis changes from some of the steps in the algorithm shown in FIG. 3;

FIG. 5 illustrates a flowchart of a method for performing a time-dependent quantum simulation in accordance with some embodiments;

FIG. 6 illustrates the simulation costs of three embodiment CFQM operators and the Suzuki operator in terms of time T when simulating the time-dependent Heisenberg model of Equation (71) for n=128 and ε=10⁻³;

FIG. 7 illustrates the simulation cost comparisons of three embodiment CFQM operators and the Suzuki operator in terms of time T when simulating the time-dependent Heisenberg model of Equation (71) for n=T and ε=10⁻³;

FIG. 8 illustrates the percentage of the contribution from each of the three error components identified in Section III to the overall simulation error in the non-split, or general case, CFQMs in the simulation shown in FIG. 7; and

FIG. 9 illustrates the implementation cost scaling of the CFQM and Suzuki operators as a function of the target error ε, for n=128 and T=1024.

Like reference numerals are used throughout the Figures to denote similar elements and features. While aspects of the invention will be described in conjunction with the illustrated embodiments, it will be understood that it is not intended to limit the invention to such embodiments.

### DETAILED DESCRIPTION OF THE INVENTION

Algorithms of quantum Hamiltonian simulation can be broadly grouped into two families of techniques: linear combination of unitaries (LCU) and product formulas. There have been proposals in each of these families for the simulation of time-dependent Hamiltonians. Notably, the Dyson series in the LCU. In the product formula category, algorithms such as the Suzuki method as described in “Higher order decompositions of ordered operator exponentials” by N. Wiebe, D. Berry, P. Høyer, and B. C. Sanders, Journal of Physics A: Mathematical and Theoretical, 43, 065203 (2010), the entire contents of which are incorporated by reference herein for all purposes, and the continuous qDRIFT method as described in “Quantum simulation of time-dependent Hamiltonians and the convenient illusion of Hilbert space” by D. Poulin et al., Physical Review Letters, 106 (17):170501 (2011), the entire contents of which are incorporated by reference herein for all purposes, have been put forth.

The Magnus operator is one of the product formula category of methods for time-dependent Hamiltonian simulation that is known in the computational mathematics community, yet its need for implementation of exponentials of commutators has dissuaded quantum computing practitioners from adopting such an approach. A key advantage of most quantum algorithms for electronic Hamiltonian simulation is their ability to efficiently achieve a specific target error. In contrast, classical algorithms implementing Magnus and quasi-Magnus operators suffer from an error that is less tightly controlled. This is at least in part due to the need to approximate the computation of each exponential, relying, for instance, on Krylov subspace methods. Classical algorithms have also often used adaptative error bounds due to their ability to copy and read states from memory. The term “bound” or “bounded” as used herein describes a parameter having a numerical value limit or range. Being able to tightly control the error bound is crucial to determine the optimal choice of orders and step size of the simulation to guarantee that the simulation achieves the target error. Additionally, classical algorithms have the advantage of being able to efficiently read, prepare, or copy any state in memory. As such, the known methods that bound the algorithmic error are, to the best knowledge of the inventors, “a posteriori” or adaptative in nature. In other words, the classical algorithms leverage knowledge of an approximate solution to compute the error incurred at each step. Unfortunately, this strategy is much less amenable to quantum computing, where preparing and reading out states is costly and requires recomputing the state preparation and time evolution up to the point of interest. Thus, no explicit “a priori” error bounds were derived for commutator-free quasi-Magnus (CFQM) operators solving the time-dependent Schrödinger equation, leaving unanswered the question of the largest time step that would guarantee a desired error when using them in a quantum algorithm.

The present disclosure is directed to a method for performing quantum simulation of a physical system that includes a time-dependent interaction with its environment or an external field. Such physical systems may be modeled with a time-dependent Hamiltonian, the temporal evolution of which represents the change in energy of the physical system. In at least one aspect, embodiments described herein enable a quantum processor to simulate a time-dependent Hamiltonian that describes a physical system efficiently by establishing an error bound of a commutator-free quasi-Magnus (CFQM) operator that approximates the time-dependent Hamiltonian whose Taylor series expansion coefficients can also be bounded. The error incurred at each approximation used in the derivation of CFQMs is determined, employing selected expressions and exploiting symmetries, resulting in a set of quantum algorithms with similar asymptotic complexity as the Suzuki method, but with better constant factor overhead for at least some classes of Hamiltonians including time-dependent Heisenberg models as described herein.

An exemplary embodiment of the physical simulation apparatus is described in Section I. A succinct derivation of CFQMs is set forth in Section II. In Section III, the derived CFQMs are analyzed where each of the approximations involved in their derivation and corresponding error bounds for each are presented. In Section IV, a detailed derivation of the error bounds is provided, and the CFQMs derived herein are compared against previous works to provide numerical estimations for the simulation error of time-dependent Heisenberg Hamiltonians. Detailed analysis is presented in Subsections A to C of Section IV. A summary of the results and the potential of the present technique in the fault-tolerant regime are presented in Section V.

### I. Simulation Apparatus

Some embodiments of the present disclosure involve operations designed to be operated or to be executed on one or more quantum computers. In further embodiments, the quantum simulation method described herein may be implemented with a synergistic hybrid approach where one or more of the steps, such as simulation initialization, may be performed on one or more classical computers operably coupled to the quantum computer(s).

In one exemplary embodiment, within a simulation initialization phase, one or more classical computers are used to define the Hamiltonian, while an initial state of the time-dependent system—whether derived classically or through a quantum circuit—is loaded onto or prepared onto one or more quantum computers operably coupled to the classical computers. The Hamiltonian is time-dependent in nature and/or may include one or more fast-forwardable terms (e.g., two fast-forwardable terms). As used herein, the expression “evolution ‘under’ a Hamiltonian” refers to the evolution or change in system energy in the physical system of interest as one or more components of the system interact with its environment or an external field over time. The quantum computer can include one or more of a variety of different qubit types, such as superconducting qubits, photonic qubits, trapped-ion qubits, silicon-based qubits, or neutral atom qubits. These devices apply gates based, for example, on the circuit(s) used for preparing the initial state. Subsequent to the loading/preparation of the initial state onto the quantum computer, a quantum simulation algorithm module (implemented in hardware, software, or a combination of both) of the quantum computer can determine local terms and a step size for the simulation (e.g., a Magnus-based simulation), and identify/dictate the gate(s) to be implemented on the quantum device. This foregoing procedure, when implemented as discussed herein, provisions the quantum computer to simulate the dynamics of the quantum system up to a target accuracy, such as chemical accuracy. According to one or more embodiments set forth herein, the ability to achieve a target error with a known simulation time step size means that the quantum simulation may be performed using the maximum simulation step size (i.e., the least number of simulation steps for a fixed total simulation time) while still producing meaningful results, thereby reducing the overall computational cost.

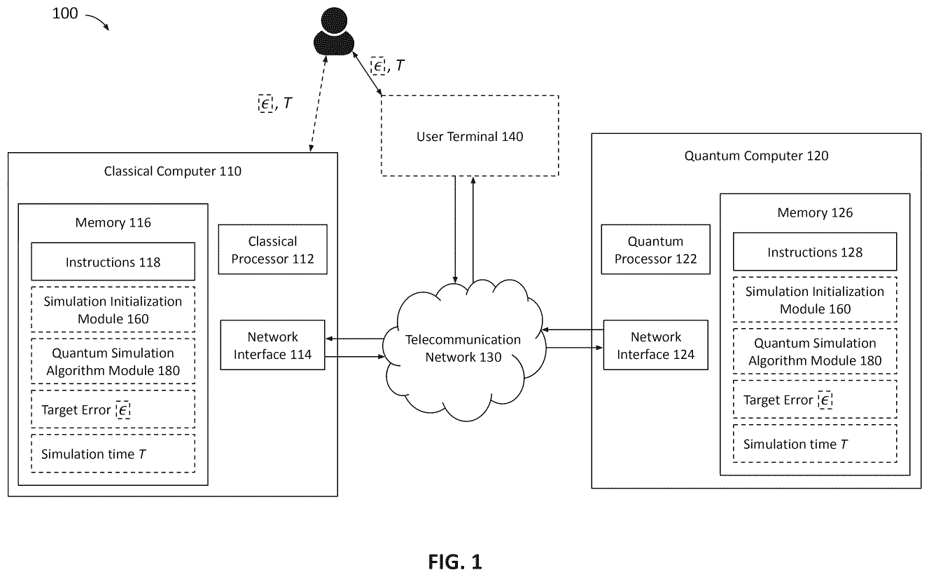

FIG. 1 is a simplified block diagram of an example embodiment of a quantum simulation system 100 in accordance with the present disclosure. As shown, system 100 includes one or more classical computers 110 that are operably coupled or in operable communication with one or more quantum computers 120, via a telecommunication network 130.

Each of the classical computer(s) 110 may be configured to perform an initialization phase of the simulation as described in more detail herein. In some embodiments, each of the classical computers 110 may be, for example, a desktop terminal, a tablet computer, a notebook computer, a server, a cloud end, or any suitable processing system. Other classical computers suitable for implementing embodiments described in the present disclosure may be used, which may include components different from those discussed below. In some examples, the classical computer 110 may be implemented across more than one physical hardware unit, such as in a parallel computing, distributed computing, virtual server, or cloud computing configuration. Although FIG. 1 shows a single instance of each component of the classical computer 110, there may be multiple instances of each component shown.

As shown in FIG. 1, the classical computer 110 may include one or more classical processors 112, such as a central processing unit (CPU) with hardware accelerator, graphics processing unit (GPU), tensor processing unit (TPU), neural processing unit (NPU), microprocessor, digital signal processor, application-specific integrated circuit (ASIC), field-programmable gate array (FPGA), dedicated logic circuitry, dedicated artificial intelligence processor unit, or combinations thereof.

The one or more classical processors 112 are operably coupled to a network interface 114 for wired or wireless communication with the telecommunication network 130 (e.g., an intranet, the Internet, a P2P network, a Wide Area Network (WAN) and/or a Local Area Network (LAN)) to operably communicate with the quantum computers 120 and one or more optional user terminals 140. The network interface 114 may include wired links (e.g., Ethernet cable) and/or wireless links (e.g., one or more antennas) for intra-network and/or inter-network communications. One or more end users may interact with system 100, for example, by inputting a Hamiltonian describing a physical system of interest and/or simulation parameters such as a target error and a total simulation time, through one or more user terminals 140 or, alternatively, inputting directly into the classical computer 110.

The classical computer 110 may also include one or more non-transitory memories 116 which may include a volatile or non-volatile memory (e.g., a flash memory, a random-access memory (RAM), and/or a read-only memory (ROM)). The non-transitory memory 116 may store instructions 118 for execution by the classical processors 112, for example, instructions to implement/execute a software-based simulation initialization module 160 and/or a software-based quantum simulation algorithm module 180, in whole or in part, each of which is described in further detail below. The memory 116 can also store representations of a target error ε (e.g., defined by user via user interaction with user terminal 140, total simulation time T, and/or one or more initial state(s), as discussed further below. Examples of non-transitory computer-readable media include a RAM, a ROM, an erasable programmable ROM (EPROM), an electrically erasable programmable ROM (EEPROM), a flash memory, a CD-ROM, or other portable memory storage.

Each of the quantum computer(s) 120 includes a quantum processor 122 operably coupled to a memory 126, and a network interface 124 (which is also operably coupled to the memory 116). The memory 126 stores instructions 128 that are executable by the quantum processor 122. The instructions 128 can include, for example, instructions to implement/execute the software-based simulation initialization module 160 and/or the software-based quantum simulation algorithm module 180, in whole or in part. The quantum computer 120 may be based on a suitable form of physical qubit, including superconducting qubits, photonic qubits, trapped-ion qubits, silicon-based qubits, and neutral atoms. The quantum processor 122 manipulates one of the physical properties of the input state by performing quantum operations such as applying unitary transformations. The quantum processor 122 may include one or more measurement components (e.g., photon number resolving detectors) configured to measure the output of the quantum processor 122 and provides information about the quantum result. The quantum computer 120 receives input to a quantum simulation process from classical computer 110 and/or user terminal 140 and returns simulation results.

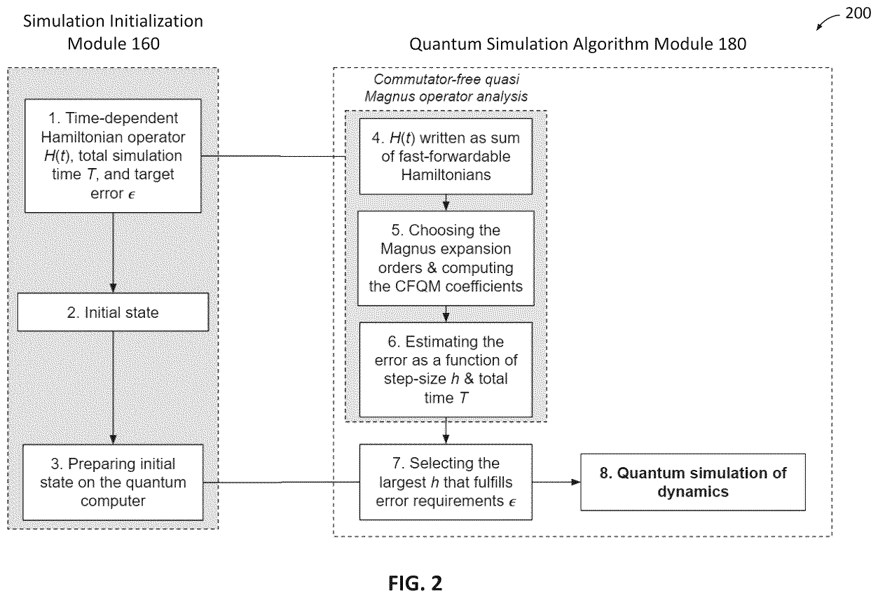

As shown in FIG. 1, the system 100 can be conceptualized as including a simulation initialization module 160 operably coupled to a quantum simulation algorithm module 180. Each of the simulation initialization module 160 and the quantum simulation algorithm module 180 can be implemented in software and/or hardware. The delineation between the simulation initialization module 160 and the quantum simulation algorithm module 180 is for ease of understanding based primarily on functionality. Both modules 160 and 180 may be implemented in full or in part on one or both of the classical computer 110 and quantum computer 120, and hence the two modules are shown in dotted lines in both computers in FIG. 1. For example, in some implementations, the simulation initialization module 160 is implemented in software as part of a classical (non-quantum) computer 110 and the quantum simulation algorithm module 180 is implemented in software as part of classical computer 110 and quantum computer 120. Alternatively, the quantum simulation algorithm module 180 can be implemented in software as part of a quantum computer 120 and the simulation initialization module 160 can be implemented in part as software on a classical (non-quantum) computer 110 and implemented in part as software on the quantum computer 120. In some implementations, at least steps 3 and 8 of the system diagram 200, shown in FIG. 2, are performed on a quantum computer, whereas one or more other steps may be performed on a classical (non-quantum) computer.

FIG. 2 is a system diagram 200 showing tasks performed by a simulation initialization module 160 and a quantum simulation algorithm module 180 (as implemented, for example, using one or more classical computers and/or one or more quantum computers, such as classical computer(s) 110 and quantum computer(s) 120 of system 100 in FIG. 1), in accordance with some embodiments. At step 1 of FIG. 2, a quantum system, defined as a physical system that can be described by quantum mechanical rules, is defined by the user onto the simulation initialization module 160. Any quantum system may be described in full generality by a Hamiltonian. For a time-dependent quantum system, its otherwise fixed Hamiltonian H takes on a time-dependent form. The time evolution of the time-dependent Hamiltonian for a time T is described by e^{-iH(T)}. In some embodiments, the quantum system is defined by the user through specifying one or more time-dependent Hamiltonians. In some embodiments, the user may also specify a “target error” ε, and a total simulation time T. A representation of the Hamiltonian H can be provided to the quantum simulation algorithm module 180 by the simulation initialization module 160, as an input to step 4. According to one or more embodiments, a simulation framework is provided that performs simulations using CFQMs set forth herein that is designed to enable efficient simulation of time-dependent quantum systems while achieving a simulation target error, as contrasted with known techniques. As used herein, the target error ε can refer to a predefined user-selected value below which the user desires the simulation error to stay (i.e., a maximum user-permissible error), and thus a goal of the simulation(s) can include achieving/maintaining a simulation error that is at or below the target error. Representations of the target error ε and/or the total time evolution T can be provided to the quantum simulation algorithm module 180 by the simulation initialization module 160, as an input to step 6 of the product formula being implemented by the quantum simulation algorithm module 180.

At step 2, and according to some embodiments, an initial state of the quantum system for which the system dynamics are to be simulated is determined, using one or more classical and/or quantum methods, such as coupled-cluster, full configuration interaction, or any other suitable method. Alternatively, the initial state may be specified using a quantum circuit provided by the user. The ability to understand/quantify how an initial state evolves under a Hamiltonian is desirable for downstream quantum algorithms applications, such as for obtaining a more accurate estimation of the ground state energy, which in turn could influence entities (e.g., industries, businesses, researchers, etc.) that create/produce applications that rely on precise simulations of fundamental properties of materials and molecules at their lowest energy state(s). Steps 1 and 2 may be combined into a single step in some embodiments.

At step 3, the simulation initialization module 160 can send a representation of the initial state determined at step 2 to the quantum simulation algorithm module 180 (e.g., as input to step 7), or can otherwise cause the initial state to be loaded onto the quantum computer for the simulation. The initial state can be loaded onto the quantum computer 120 using, for example, a sum of Slaters procedure (e.g., as described in “Initial state preparation for quantum chemistry on quantum computers” by S. Fomichev et al., arXiv preprint, arXiv: 2310.18410 (2023), the entire contents of which are incorporated by reference herein for all purposes), quantum phase estimation, or by implementing the provided quantum circuit on the quantum computer 120.

Steps 4-6 of FIG. 2 represent an example Magnus-series-based simulation approach according to one or more embodiments of the present disclosure. All of the above-cited known methods require the time-dependent Hamiltonian to be approximated as a sum of terms. For example, Dyson-based methods require the terms to be unitaries, while Trotter-based approaches require the terms to be local and Hermitian. To achieve an efficient simulation algorithm, the Magnus-based approach described herein approximates the time-dependent Hamiltonian as a sum of fast-forwardable Hamiltonians using Magnus expansion. The term “fast-forwardable” means that the cost of implementing the time evolution of the Hamiltonian in gate complexity scales at most logarithmically with respect to time. Such a decomposition may be found in electronic structure systems: H(t)=T(t)+V(t), where the kinetic potential T(t) and Coulomb potential V(t) are fast-forwardable Hamiltonians.

At step 5, the Magnus-based approximation of the time evolution ultimately leads to some Magnus product formula of the evolution of the local terms at select time points with time step increments h. To obtain the formula of this product, the order of the operator should be chosen. Such order indicates where to truncate the Taylor series of the Magnus evolution, thus approximating the time evolution. The Magnus-based approximation includes nested commutators of the local terms which are difficult to implement on a quantum computer. Therefore, a so-called (quasi-)Magnus commutator-free formula of the same order is used to approximate the evolution of these nested commutators. In some embodiments, the commutator-free conversion includes the determination of coefficients that are determined by an efficient algorithm on classical computer 110.

At step 6, each choice of order and the commutator-free conversion performed at step 5 induce an error as a function of h and T. These errors accumulate and must be accounted for. In some embodiments, three types of errors are taken into account. The first is an error due to the definition of the commutator-free formula, which matches the Magnus operator up to a desired order. The second is a quadrature error due to approximating the integrals that appear. The third is a product formula error to implement the result as a product of exponentials of fast-forwardable terms.

At step 7, the largest value of the time step h is determined in terms of relevant terms such as the target error, the norm of the Hamiltonian at different steps, and the total time T to ensure that the overall simulation error is less than or equal to the target error. Intuitively, the largest simulation step size implies the least number of simulations to be performed, thereby minimizing the computational cost.

At step 8, the quantum system dynamics are determined by applying, on a quantum computer, the commutator-free quasi-Magnus product formula on the initial state prepared in step 3. A sequence of evolutions can be applied to the initial state, using the quantum circuit, to yield the dynamics and/or energy of the initial state, and based on the dynamics and/or energy of the initial state, the energy of an eigenstate of interest can be determined with an accuracy that is within the target error ε. This could be used in downstream tasks that require the evolution of a state under a time-dependent Hamiltonian such as adiabatic preparation of a quantum state, preparation of excited states from the ground state, simulating the interaction of the system of interest with an external field such as an electromagnetic field, and computing transition amplitudes.

One or more embodiments of the present disclosure facilitate the simulation of time-dependent quantum systems with an accuracy that is within a specified target error, as contrasted with known approaches to such simulations. For example, embodiments set forth herein can accurately quantify and bound a simulation error expressed as a function of, among other parameters, the simulation step size h. Alternatively or in addition, one or more embodiments of the present disclosure facilitate the more efficient implementation of time-dependent quantum system simulation by achieving an overall simulation error that is within a target error by executing the least number of simulation steps (i.e., using the greatest simulation step size h within a specified simulation time T), as contrasted with known quantum simulation techniques.

### II. Commutator-Free Quasi-Magnus (CFQM) Operators Derivation

As may be observed from the time-independent Schrödinger equation, the operator e^{-iH(t)} functions as the time propagator for a time-independent Hamiltonian H. A Magnus operator Ω(t) as a function of time t is defined such that e^{Ω(t)} is a propagator of the time-dependent Schrödinger equation:

$${\partial }_{t} ψ ( t ) = - iH ( t ) ψ ( t ) = A ( t ) ψ ( t ) . \qquad ( 1 )$$

If the Hamiltonian A(t) is time dependent, the Magnus operator is of the form:

$$Ω ( {t}_{0} , {t}_{0} + t ) = {\sum }_{n = 1}^{∞} {Ω}_{( n )} ( {t}_{0} , {t}_{0} + t ) , \qquad ( 2 )$$

with Ω₍₁₎(t₀, t₀+t)=∫ₜ_{₀}^{t}^{₀}^{+t}dτA(τ) and higher orders of the Magnus operator inductively defined as:

$${Ω}_{( n )} ( {t}_{0} , {t}_{0} + t ) = {\sum }_{j = 1}^{n - 1} \frac{{b}_{j}}{j !} {\sum }_{{k}_{1} + … + {k}_{j} = n - 1} {\int }_{{t}_{0}}^{{t}_{0} + t} {ad}_{{Ω}_{{k}_{1} ( τ )}} … {ad}_{{Ω}_{{k}_{j} ( τ )}} A ( τ ) d τ , \qquad ( 3 )$$

where ad_{B}(C):=[B, C] with B and C being arbitrary operators, and the bⱼ's are the Bernoulli numbers appearing as coefficients in the Taylor series of

$$\frac{z}{{e}^{z} - 1} .$$

The series in Equation (2) has a finite radius of convergence over t, and therefore does not always converge. Thus, to obtain a global solution, the total time of evolution is apportioned into a plurality of time segments. The operator Ω(t₀, t₀+t) has been proven to be absolutely convergent, and thus well defined, if

$${\int }_{{t}_{0}}^{{t}_{0} + t} ‖ A ( τ ) ‖d τ \leq 1.086869 , \qquad ( 4 )$$

or alternatively if

$${max}_{τ ∈ [ {t}_{0} , {t}_{0} + t ]} ‖ A ( τ ) ‖ t < 2.$$

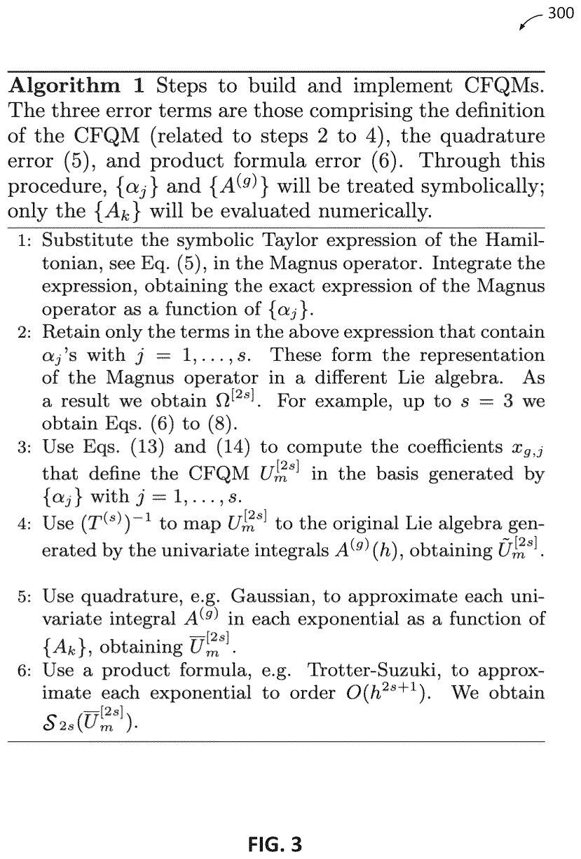

Implementing the Magnus operator in its original form is complicated as it requires using exponentials of integrals of commutators as shown in Equation (3). While there exist known quantum algorithms to implement such exponentials, some embodiments of the present disclosure utilize commutator-free operators that approximate Ω(t₀, t₀+t). FIG. 3 illustrates a pseudo code for an Algorithm 1 for deriving CFQMs for a given time-dependent Hamiltonian Ω(t) in accordance with one aspect of the present disclosure described more fully in Subsections A and B below.

### A. Lie Algebras and Basis Changes

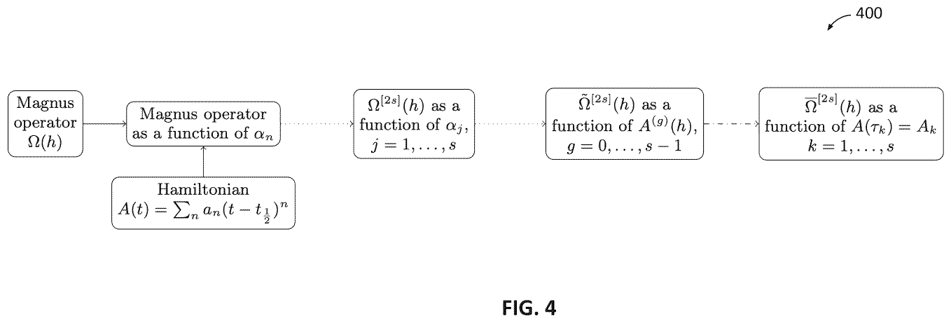

FIG. 4 illustrates a flowchart 400 of the conversions and basis changes described in this Subsection A. In FIG. 4, the dash-dot line indicates equality up to O(h^{2s+1}); the dotted line indicates formal equality; and the solid line indicates exact rewriting or use of an expression (Taylor series of the Hamiltonian). Let h=Δt denote the length of time in each of the time segments needed to apportion the time-dependent evolution. Thus, the Magnus operators are of the form Ω(t₀, t₀+h), which is notated as Ω(h) from here onward for brevity and clarity as the analysis and equations presented herein apply identically for any t₀. The same notation abbreviation may be adopted to other functions and/or expressions that are similarly defined on the segments.

Referring back to FIG. 3, to derive a CFQM, in step 1 of Algorithm 1, the Taylor series of the Hamiltonian is expanded at the midpoint of each segment

$${t}_{\frac{1}{2}} = {t}_{0} + \frac{h}{2} ,$$

$${A ( t ) = {\sum }_{n = 0}^{∞} {{a}_{n} ( t - {t}_{\frac{1}{2}} )}^{n} , {a}_{n} = \frac{1}{n !} \frac{{d}^{n} A ( t )}{{dt}^{n}} \vert}_{t = {t}_{\frac{1}{2}}} . \qquad ( 5 )$$

Defining αₙ: =aₙ₋₁hⁿ, the αₙ's then form the basis of a Lie algebra indexed by their O(hⁿ) order. This property of the Lie algebra provides a basis set to simplify the structure of the Magnus operator Ω(t₀, t₀+h) by reducing the number of commutators. The function

$$Ω ( {t}_{\frac{1}{2}} - \frac{h}{2} , {t}_{\frac{1}{2}} + \frac{h}{2} ) = - Ω ( {t}_{\frac{1}{2}} + \frac{h}{2} , {t}_{\frac{1}{2}} - \frac{h}{2} )$$

is antisymmetric around

$${t}_{\frac{1}{2}} .$$

As a result, only odd powers of h will appear in the expansion of Ω(h) around

$${t}_{\frac{1}{2}} .$$

The formal representations Ω^{[2s]}(h) of the 2s-th order expansion of Ω(h) may be approximated in the Lie algebra generated by αᵢ with i=1, . . . , s. This may be performed at step 2 of Algorithm 1 by selecting the terms involving those α's in the Taylor expansion of the Magnus operator. By way of non-limiting examples,

$${Ω}^{[ 2 ]} ( h ) = {α}_{1} , \qquad ( 6 )$$

$${Ω}^{[ 4 ]} ( h ) = {α}_{1} - \frac{1}{12} [ 1 , 2 ] , \qquad ( 7 )$$

$${Ω}^{[ 6 ]} ( h ) = {α}_{1} - \frac{1}{12} [ 1 , 2 ] + \frac{1}{12} {α}_{3} + \frac{1}{240} [ 2 , 3 ] + \frac{1}{360} [ 1 , 1 , 3 ] - \frac{1}{240} [ 2 , 1 , 2 ] + \frac{1}{720} [ 1 , 1 , 1 , 2 ] , \qquad ( 8 )$$

where [k₁, . . . , jₖ] is a compact notation for [αⱼ_{₁}, [. . . [αⱼ_{_{k−1}}, αⱼ_{ₖ}]]] of order O(h^{j}^{₁}^{+. . . +j}^{ₖ}). The argument h may be omitted for brevity and clarity. Note that there are missing terms in Equations (6) to (8). For example,

$$\frac{1}{12} {α}_{3}$$

does not appear in Ω^{[4]}(h), even though it is an O(h³) term. Similarly,

$$\frac{1}{80} {α}^{5} and - \frac{1}{80} [ 1 , 4 ]$$

are missing from Ω^{[6]}(h) even though both are O(h⁵) terms.

The missing terms are recovered by numerically approximating the integrals at the quadrature nodes cₖ of each time interval, such as those prescribed by the Gauss-Legendre method. Then, evaluating the Hamiltonian at s quadrature nodes, e.g.,

$${A}_{k} := A ( {c}_{k} \frac{h}{2} + {t}_{\frac{1}{2}} )$$

with cₖ[−1, 1], allows a 2s-order approximation of the Magnus operator Ω(h) to be obtained, as demonstrated in “On the solution of linear differential equations in Lie groups” by A. Iserles and S. P. Nørsett, Philosophical Transactions of the Royal Society of London. Series A: Mathematical, Physical and Engineering Sciences, 357, 983 (1999), the entire contents of which are incorporated by reference herein for all purposes.

A change of basis is performed prior to obtaining the approximation in terms of Aₖ. In some embodiments, the Lie algebras are converted to an intermediate set of variables, for example univariate integrals. In one or more embodiments, suitable univariate integrals may be defined as:

$${A}^{( g )} ( h ) := \frac{1}{{h}^{g}} {\int }_{0}^{h} {( τ - {t}_{\frac{1}{2}} )}^{g} A ( t ) dt = \frac{1}{{h}^{g}} {\int }_{- \frac{h}{2}}^{\frac{h}{2}} {t}^{g} A ( t + {t}_{\frac{1}{2}} ) dt = {\sum }_{j = 0}^{∞} \frac{1 - {( - 1 )}^{g + j + 1}}{( i + j + 1 ) {2}^{g + j + 1}} {α}_{j + 1} = {\sum }_{j = 1}^{∞} {T}_{g , j} {α}_{j} . \qquad ( 9 )$$

Note the change of variable j+1→j in the last equality in Equation (9). Expressing the Magnus operator referenced in Equations (6) to (8) in terms of the univariate integrals permits the recovery of the missing terms. For example,

$${A}^{( 0 )} ( h ) = {α}_{1} + \frac{1}{12} {α}_{3} + \frac{1}{80} {α}_{5} + … . \qquad ( 10 )$$

The univariate integrals in Equation (9) similarly form the basis of a Lie algebra. At step 4 of Algorithm 1, the operator \tilde{Ω}^{[2s]}(h) is defined by rewriting the Magnus operator Ω^{[2s]}(h) in terms of the univariate integrals {A^{(g)}}, with g=0, . . . , s−1, using (T^{(s)})⁻¹, where T^{(s)} is a matrix with elements T_{g,j} defined in Equation (9) with g=0, . . . , s−1 and j=1, . . . , s. For example, the intermediate operator for a 4^{th} order Magnus operator expressed in univariate integrals is:

$${\tilde{Ω}}^{[ 4 ]} ( h ) = {A}^{( 0 )} ( h ) + [ {A}^{( 1 )} ( h ) , {A}^{( 0 )} ( h ) ] . \qquad ( 11 )$$

All the missing terms in Equations (6) to (8) may be recovered by fully expanding the intermediate operator \tilde{Ω}^{[2s]}(h) in terms of αⱼ's using Equation (9). For example, by using Equation (10), the intermediate operator \tilde{Ω}^{[4]}(h) now includes

$$\frac{1}{12} {α}_{3}$$

as well as

$$\frac{1}{80} {α}^{5}$$

which were missing from Equation (7).

The univariate integrals may then be approximated by using a quadrature method, for instance Gauss-Legendre. With the recovery of the missing O(h^{2s}) terms, there is provided an O(h^{2s+1})-accurate quadrature-based exponential expression of the Magnus operator in

quadrature, Ω̅^{[2s]}(h), that is a function of the Hamiltonian evaluated at the s quadrature nodes of each time segment, {Aₖ}.

### B. Commutator-Free Quasi-Magnus Operators

The one or more quadrature-based exponentials are used to define CFQM operators that approximate the Magnus operator to a desired order. In some embodiments, an initial ansatz of the CFQM is defined as:

$${\tilde{U}}_{m}^{[ 2 s ]} := {\prod }_{i = 1}^{m} exp ( {\sum }_{g = 0}^{s - 1} {y}_{i , g} {A}^{( g )} ) = exp ( {\tilde{Ω}}^{[ 2 s ]} ) + O ( {h}^{2 s + 1} ) , \qquad ( 12 )$$

where y_{i,g} are the coefficients to be determined, m indicates the number of exponentials, and parameter h is omitted from the operators in Equation (12) for brevity and clarity. The expression in Equation (12) may be simplified in the αⱼ graded basis due to a reduction in the number of commutators in the expression:

$${U}_{m}^{[ 2 s ]} := {\prod }_{i = 1}^{m} exp ( {\sum }_{j = 1}^{s} {x}_{i , j} {α}_{j} ) = exp ( {Ω}^{[ 2 s ]} ) + O ( {h}^{2 s + 1} ) , \qquad ( 13 )$$

where parameters x_{i,j} represent the coefficients to be determined. In order to respect physical time symmetry, the goal is to obtain a time-antisymmetric expression in the form of:

$${x}_{m + 1 - i , j} = {( - 1 )}^{j + 1} {x}_{i , j} . \qquad ( 14 )$$

Thus, for a given value m of exponentials, there are ms/2 parameters to replicate Ω^{[2s]}(h) up to order O(h^{2s+1}), which, in turn, imposes a minimum value of m for each order s. At step 3 of Algorithm 1, the coefficients x_{i,j} may be determined by expanding both sides of Equation (13) in the Taylor series and solving the equations to reproduce the equality it imposes to an order of O(h^{2s+1}). Alternative methods of coefficient determination may be used, such as the ones described in “Fourth-and sixth-order commutator-free Magnus integrators for linear and non-linear dynamical systems” by S. Blanes and P. C. Moan, Applied Numerical Mathematics 56, 1519 (2006), the entire contents of which are incorporated by reference herein for all purposes.

At step 5 of Algorithm 1, upon determination of the coefficients x_{i,j}, the operator in the αⱼ graded basis from Equation (13) may be converted to the univariate integral basis. The resulting operator Ũₘ^{[2s]} contains univariate integrals that are approximated using Gaussian quadrature with coefficients Aₖ:

$${\overline{U}}_{m}^{[ 2 s ]} ( h ) := {\prod }_{i = 1}^{m} exp ( {\sum }_{k = 1}^{s} {z}_{i , k} {A}_{k} h ) = exp ( {\overline{Ω}}^{[ 2 s ]} ( h ) ) + O ( {h}^{2 s + 1} ) \qquad ( 15 )$$

Optionally, at step 6 of Algorithm 1, each exponential in Ūₘ^{[2s]} may be implemented on a quantum computer, such as quantum computer 120 in FIG. 1, via a 2s-order product formula obtained through suitable methods, such as the Trotter-Suzuki method,

$${𝒮}_{2 s} ( {\overline{U}}_{m}^{[ 2 s ]} ( h ) ) := {\prod }_{i = 1}^{m} {𝒮}_{2 s} ( exp ( {\sum }_{k = 1}^{s} {z}_{i , k} {A}_{k} h ) ) . \qquad ( 16 )$$

The expression in Equation (16) assumes the exponents Σₖ₌₁^{s}z_{i,k}Aₖh are decomposed into fast-forwardable terms, whose implementation cost grows polylogarithmically in the evolution time and accuracy, and they may be conceptualized as being the quantum equivalent to exactly integrable Hamiltonian terms.

In an alternative embodiment referred to herein as the “split-operator approach”, step 6 for product formula conversion may be avoided. In other words, the quadrature-based product formula in its original form can be directly implemented on the quantum computer without further approximation. In this embodiment, as described in more detail below, the Hamiltonian is partitioned into one or more self-commuting fast-forwardable terms. An example application for the split-operator approach is the electronic structure Hamiltonians where both the kinetic T(t)≡T and Coulomb potential V(t) are not only fast-forwardable but also self-commuting at different times. In such a case, the derivation in Equation (15) above is modified to determine compositions of the form:

$${W}_{{m}_{s}}^{[ 2 s ]} = {\prod }_{j = 1}^{{m}_{s}} [ exp ( - i {θ}_{j} Th ) exp ( - i {\sum }_{k} {v}_{j , k} V ( {t}_{k} ) h ) ] . \qquad ( 17 )$$

### III. Error Bounds

Once the product formula that may be simulated on a quantum computer is derived, its associated range of error, or an “error bound”, for the overall error of implementing CFQMs on a quantum computer is to be determined. In some embodiments, the following triangle inequality is defined to facilitate the determination of the error bound, where h is left implicit:

$$‖ exp ( Ω ) - {2 s}_{} ( {\overline{U}}_{m}^{[ 2 s ]} ) ‖ \leq ‖ exp ( Ω ) - {\tilde{U}}_{m}^{[ 2 s ]} ‖ + ‖ {\tilde{U}}_{m}^{[ 2 s ]} - {\overline{U}}_{m}^{[ 2 s ]} ‖ + ‖ {\overline{U}}_{m}^{[ 2 s ]} - {2 s}_{} ( {\overline{U}}_{m}^{[ 2 s ]} ) ‖ . \qquad ( 18 )$$

In essence, the triangular inequality of Equation (18) states that the overall error, i.e., the difference between the original Magnus operator Ω and its product formula representation, is bounded by the sum of three separate error components, namely a univariate intermediate operator definition error ∥exp(Ω)−Ũₘ^{[2s]}, a quadrature error ∥Ũₘ^{[2s]}−Ūₘ^{[2s]}∥, and an optional product formula conversion error ∥Ūₘ^{[2s]}− [symbol] ₂ₛ(Ūₘ^{[2s]}). Note that Equation (18) reflects the steps in the derivation and implementation illustrated in Algorithm 1 from FIG. 3. The univariate intermediate operator definition error ∥exp(Ω)−Ũₘ^{[2s]}∥ stems from the y_{i,g} parameter fixing in the CFQM definition from Equation (12).

In one aspect, the derivation procedure for bounding the first error term, namely the univariate intermediate operator definition error, allows for the Taylor series expansion of both terms in Equation (12) to match up to the order O(h^{2s+1}).

In some embodiments, the univariate intermediate operator definition error as may be decomposed into two separate terms as follows:

$$‖ exp ( Ω ) - {\tilde{U}}_{m}^{{}_{{}^{[ 2 s ]}}} ‖ \leq {\sum }_{p = 2 s + 1}^{∞} ( ‖ {exp ( Ω )}_{p} ‖ + ‖ {\tilde{U}}_{m , p}^{{}_{{}^{[ 2 s ]}}} ‖ ) , \qquad ( 19 )$$

where ∥exp(Ω)ₚ∥ and ∥Ũ_{m,p}^{[2s]}∥ represent the norm of the Θ(h^{p}) term in the Taylor expansion of exp(Ω)ₚ and Ũₘ^{[2s]}, respectively. As both ∥exp(Ω)ₚ∥ and ∥Ũ_{m,p}^{[2s]}∥ terms represent the Taylor series term of order O(h^{2s+1}), the univariate intermediate operator definition error may also be referred to as the Taylor series truncation error of the Magnus and quasi-Magnus operators, respectively.

### A. Taylor Remainder of the Magnus Operator

The Taylor series expansions of the Magnus operator and the CFQM operator match up when truncated to a certain order. The difference between the two expressions stems primarily from the remainder of their respective Taylor series representations. Here, the error bound for the truncated Magnus operator is determined.

The notation [symbol] (p) is used to denote the integer compositions of p∈N. Each such composition is a way of decomposing p into positive integers, where order matters. For instance, [symbol] (3)={[3], [2,1], [1,2], [1,1,1]}, where [2,1] corresponds to 3=2+1, and each element has a “dimension” which is its size (e.g., dim([1,2])=2. The compositions of dimension z are denoted by [symbol] ^{z}(p). Let the coefficients aⱼ of the Taylor series of A(t) be uniformly bound by c≥∥αⱼ∥, ∀j.

Let A(t) be a bounded operator, with its Taylor coefficients bounded by c. Let h be the step size of the Magnus operator Ω. Let exp(Ω)ₚ be the Θ(h^{p})-term in the Taylor expansion of exp(Ω). Then the error bound for the truncation of the Taylor series of the Magnus operator may be defined as:

$${\sum }_{p = 2 s + 1}^{∞} ‖ {exp ( Ω )}_{p} ‖ \leq {\sum }_{p = 2 s + 1}^{∞} [ {( \frac{h}{2} )}^{p} \cdot \frac{1}{( dim k ) !} {\prod }_{l = 1}^{dim k} \frac{{( 2 c )}^{dim {j}_{l}}}{dim {j}_{l}} {\prod }_{{ℓ}_{l} = 1}^{dim {j}_{l}} \frac{1}{{j}_{{ℓ}_{l}}} ] . \qquad ( 20 )$$

Detailed derivation of Equation (20) is presented in Subsection IV.A.

### B. Taylor Remainder of the Quasi-Magnus Operator

The remainder terms of the Taylor series of the CFQM operator from Equation (12) can now be determined. An extension of x_{i,j} for values j>s is defined as:

$${\overline{x}}_{i , j} := {\sum }_{g = 0}^{s - 1} {y}_{i , g} \frac{1 - {( - 1 )}^{g + j}}{( g + j ) {2}^{g + j}} , \qquad ( 21 )$$

where x̅_{i,j} increases inversely exponential with j, as seen in the denominator term in Equation (21). Then, the expression ∥x̅_{i,j}αⱼ∥=∥x̅_{i,j}αⱼ₋₁∥h^{j}≤c̅h^{j} is uniformly bound by the smallest possible c̅. Since the values of x̅_{i,j} may be ascertained from its formal definition, effectively, this is a condition to bound the coefficients of the Taylor expansion of the time-dependent Hamiltonian.

With h and c̅ defined as above, let Ũₘ^{[25]} be the 2s-order m-exponential CFQM operator, expressed in terms of the univariate integrals A^{(g)}(h) in Equation (12). Let Ũ_{m,p}^{[2s]} be the Θ(h^{p})-term in its Taylor expansion. The remainder terms of the CFQM following the matching terms may be then summed as:

$${\sum }_{p = 2 s + 1} ‖ {\tilde{U}}_{m , p}^{{}_{{}^{[ 2 s ]}}} ‖ \leq {\sum }_{p = 2 s + 1}^{∞} {h}^{p} {\sum }_{{k : {Σ}_{i = 1}^{m} {k}_{i}}_{= dim w}} \frac{{\overline{c}}^{{k}_{1}} … {\overline{c}}^{{k}_{m}}}{{k}_{1} ! … {k}_{m} !} . \qquad ( 22 )$$

Detailed derivation of Equation (22) is presented in Subsection IV.B.

### C. Quadrature Error

The quadrature error refers to the error incurred by approximating the A^{(g)}(h) integrals in the CFQM by evaluating the Hamiltonian at several points. By way of a non-limiting example, the derivations shown herein use the Gauss-Legendre quadrature, with the full derivation proof shown in Subsection IV.C. However, it is understood that other quadratures may also suffice.

Let Ũₘ^{[2s]} represent the commutator-free Magnus operator as a function of the univariate, integrals and with coefficients yⱼ⁽ⁱ⁾ as per Equation (12). Let Ũₘ^{[2s]} be the operator where the integrals have been approximated via Gauss-Legendre quadrature. Let Rₛ(A) denote the residual due to approximating the integral A with quadrature of order 2s. Then, it follows that the quadrature error may be defined as follows:

$$‖ {\tilde{U}}_{m}^{{}_{[ 2 s ]}} - {\overline{U}}_{m}^{{}_{[ 2 s ]}} ‖ \leq {\sum }_{i = 1}^{m} {\sum }_{g = 0}^{s - 1} ‖ {y}_{i , g} {R}_{s} ( {A}^{( g )} ( h ) ) ‖ \leq \frac{{{h}^{2 s + 1} ( s ! )}^{4}}{( 2 s + 1 ) {( ( 2 s ) ! )}^{3}} {\sum }_{i = 1}^{m} {\sum }_{g = 0}^{s - 1} \frac{\vert {y}_{i , g} \vert}{{h}^{g}} {\sum }_{j = 0}^{∞} \frac{( j + 2 s ) !}{j !} \frac{{h}^{j}}{{2}^{j}} ‖ {a}_{j} ‖ . \qquad ( 23 )$$

To compute this error term in Equation (23), the following known result for unitary operators is applied:

$$‖ {e}^{{X}_{1}} … {e}^{{X}_{m}} - {e}^{{Y}_{1}} … {e}^{{Y}_{m}} ‖ \leq {\sum }_{j = 1}^{m} ‖ {e}^{{X}_{j}} - {e}^{{Y}_{j}} ‖ , \qquad ( 24 )$$

along with Corollary 1, the details of which are presented in Subsection IV.C. Corollary 1 states: given [symbol] and [symbol] , two anti-Hermitian continuous operator-valued functions defined on [symbol] ,

$$‖ 𝒯 exp ( {\int }_{{t}_{1}}^{{t}_{2}} d τℋ ( τ ) ) - 𝒯 exp ( {\int }_{{t}_{1}}^{{t}_{2}} d τ 𝒢 ( τ ) ) ‖ \leq {\int }_{{t}_{1}}^{{t}_{2}} d τ ‖ ℋ ( τ ) - 𝒢 ( τ ) ‖ . \qquad ( 25 )$$

The quadrature error from using quadrature to approximate each exponential Xᵢ=Σ_{g=0}^{s-1}y_{i,g}A^{(g)}(h) in Ũₘ^{[2s]} may be determined. The univariate integral A^{(g)}(h) may be approximated with quadrature as follows:

$${\int }_{a}^{b} f ( x ) dx = {\sum }_{i = 1}^{n} {w}_{i} f ( {c}_{i} ) + {R}_{n} . \qquad ( 26 )$$

The expression in Equation (26) can be bounded using the following:

$${R}_{n} ( {\int }_{a}^{b} f ) = \frac{{( b - a )}^{2 n + 1} {( n ! )}^{4}}{( 2 n + 1 ) {( ( 2 n ) ! )}^{3}} {f}^{( 2 n )} ( ξ ) , a < ξ < b , \qquad ( 27 )$$

which in turn permits the determination of ∥y_{i,g}Rₛ(A^{(g)}(h))∥ and demonstrate Equation (23).

### D. Product Formula Error

The optional product formula error ∥Ūₘ^{[2s]}− [symbol] ₂ₛŪₘ^{[2s]})∥ stems from the error due to approximating the exponentials in Ūₘ^{[2s]} into fast-forwardable exponentials. In some embodiments, the implementation cost of such exponentials grows at most polylogarithmically in the simulation time, and optimized methods of the exponential's implementation, such as those described in “Linear and logarithmic time compositions of quantum many-body operators” by F. Motzoi, M. P. Kaicher, and F. K. Wilhelm, Physical review letters 119, 160503 (2017), the entire contents of which are incorporated by reference herein for all purposes, are known in the art.

In some embodiments, the product-formula approximation may be done by applying the Trotter-Suzuki method, also referred to as Trotterization. In such embodiments, error bounds derived in the literature for Trotter-Suzuki product formulas can be directly applied to each exp(Σₖz_{i,k}Aₖ) in Ūₘ^{[2s]}; and then combined with Equation (24) to characterize the errors incurred during the usage of CFQMs.

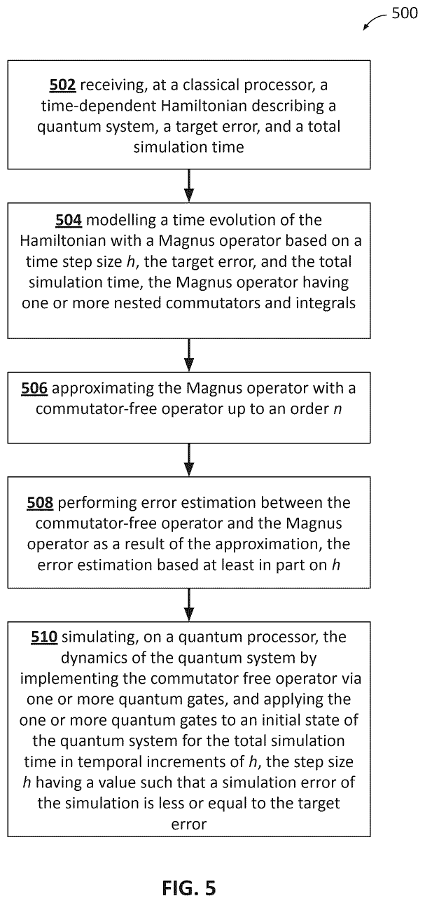

FIG. 5 is a flowchart of a method 500 for performing a time-dependent quantum simulation, in accordance with some embodiments. The method 500 can be performed through the execution of instructions stored in a non-transitory, processor-readable medium. Alternatively or additionally, the method 500 can be implemented using one or more classical computers and/or one or more quantum computers, such as classical computer(s) 110 and quantum computer(s) 120 of FIG. 1. Alternatively or additionally, the method 500 may be performed on a quantum computer that includes a processor and a memory storing, for example, software such as the quantum simulation algorithm module 180 of FIG. 2.

As shown in FIG. 5, the method 500 includes receiving, at 502 and a classical computer, a time-dependent Hamiltonian describing a quantum system, a target error, and a total simulation time. The method further includes, at 504, modeling a time evolution of the Hamiltonian with a Magnus operator based on a time step size h, the target error, and the total simulation time, the Magnus operator having one or more nested commutators and integrals. At 506, the method 500 includes approximating the Magnus operator with a commutator-free operator up to an order n. At 508, the method 500 includes performing error estimation between the commutator-free operator and the Magnus operator as a result of the approximation, the error estimation based at least in part on h. At 510, the method 500 includes simulating, on a quantum processor, the dynamics of the quantum system by implementing the commutator-free operator via one or more quantum gates, and applying the one or more quantum gates to an initial state of the quantum system for the total simulation time in temporal increments of h, the step size h having a value such that a simulation error of the simulation is less than or equal to the target error.

### E. Split Operator

In some embodiments, at least one Hamiltonian term commutes with itself at two different times and is fast-forwardable. In such cases, the optional step of converting the quadrature approximation into a product formula approximation (i.e., step 6 of Algorithm 1 in FIG. 3) may be bypassed.

By way of a non-limiting example, for electronic structures, the Hamiltonian is of the form −iH(t)=T(t)+V(t), where [T(t), T(t′)]=[V(t), V(t′)]=0, ∀t, t′. Both operators T(t) and V(t) are fast-forwardable operators. The corresponding Magnus operator may be expanded as a product formula:

$${W}_{{m}_{s}}^{[ 2 s ]} = {\prod }_{l = 1}^{{m}_{s}} {e}^{{}_{{\tilde{T}}_{i}}} {e}^{{}_{{\tilde{V}}_{i}}} , {\tilde{T}}_{i} = {\sum }_{j = 1}^{s} {\overline{t}}_{i j} {θ}_{j} , {\tilde{V}}_{i} = {\sum }_{j = 1}^{s} {\overline{v}}_{i j} {v}_{{j}^{,}} \qquad ( 28 )$$

where θⱼ and vⱼ are Lie algebra generators akin to αⱼ described above. Further, the parameters t̅ᵢⱼ and v̅ᵢⱼ function as the same time anti-symmetry constraint as xᵢⱼ in Equation (14). Similar to the general case, the process in finding the coefficients starts by expanding both operators into the Taylor series:

$$V ( t ) = {\sum }_{j = 0}^{∞} {{v}_{j} ( t - {t}_{\frac{1}{2}} )}^{j} , {v}_{j} = \frac{1}{j !} \frac{{d}^{j} V ( t )}{d {t}^{j}} {\vert}_{{{}_{t = {t}_{\frac{1}{2}}}}^{}} , \qquad ( 29 )$$

$$T ( t ) = {\sum }_{j = 0}^{∞} {{w}_{j} ( t - {t}_{\frac{1}{2}} )}^{j} , {w}_{j} = \frac{1}{j !} \frac{{d}^{j} T ( t )}{d {t}^{j}} {\vert}_{{{}_{t = {t}_{\frac{1}{2}}}}^{}} . \qquad ( 30 )$$

The expansions in Equations (29) and (30) are substituted into the Magnus series recursion, obtaining an expression similar to Equations (6) to (8). Then portions from both expressions that are to be equated up to an order of 2s, for example exp(Ω^{[2s]}) and Wₘ_{ₛ}^{[2s]}, are expanded in Taylor series of h to the appropriate order. Parameters t̅ᵢⱼ and v̅ᵢⱼ are selected to fit the coefficients in both Taylor series of the Magnus operator. The terms vᵢ and wᵢ are expressed in terms of univariate integrals, denoted with \tilde{W}ₘ_{ₛ}^{[2s]}, and reduced using an appropriate order quadrature as:

$${\overline{T}}_{i} = {\sum }_{k = 1}^{s} {ρ}_{ik} {T}_{k} h , {\overline{V}}_{i} = {\sum }_{k = 1}^{s} {σ}_{ik} {V}_{k} h , \qquad ( 31 )$$

where

$${R}^{( m , k )} = {A}^{( m , s )} {R}^{( s )} {Q}^{( s , k )} , {S}^{( m , k )} = {B}^{( m , s )} {R}^{( s )} {Q}^{( s , k )} \qquad ( 32 )$$

for (R^{(m,k)})ᵢⱼ=ρᵢⱼ and (S^{(m,k)})ᵢⱼ=σᵢⱼ. Matrices A^{(m,s)} and B^{(m,s)} contain the parameters t̅ᵢⱼ and v̅ᵢⱼ respectively, which are to be determined. R^{(s)} is the inverse of T^{(s)}, while Q^{(s,k)} is the quadrature matrix

$${Q}^{( s , k )} = ( \begin{matrix}{w}_{1} & … & {w}_{k} \\ ⋮ & ⋱ & ⋮ \\ {w}_{1} {c}_{1}^{s - 1} & … & {w}_{k} {c}_{k}^{s - 1}\end{matrix} ) , \qquad ( 33 )$$

with wₖ and cₖ∈(−1, 1) being the weights and nodes of the quadrature, respectively. Consequently, the split-operator CFQM is obtained as follows:

$${\overline{W}}_{{m}_{s}}^{[ 2 s ]} = {\prod }_{i = 1}^{{m}_{s}} ( exp [ {\sum }_{k = 1}^{s} {ρ}_{ik} {T}_{k} h ] exp [ {\sum }_{k = 1}^{s} {σ}_{ik} {V}_{k} h ] ) . \qquad ( 34 )$$

Since operators Tₖ and Vₖ commute with themselves at different times and are fast-forwardable, the resulting exponentials may be fast-forwarded by implementing the individual evolutions exp(ΣⱼρᵢₖTₖh) and exp(ΣⱼσᵢₖVₖh) without the need for product formula decompositions.

With respect to the error bound of the split operator approach, the product formula error term is obviated from Equation (18) as the Hamiltonian is already decomposed, or split, into terms with one or more fast-forwardable Hamiltonians. Accordingly, the expression in Equation (18) is reduced to just two error terms, namely the univariate intermediate operator definition error and the quadrature error.

The quadrature error is similar to that of the general case in Equation (18), except that the norm ∥αⱼ∥ of Hamiltonian A(t) and its derivatives are substituted by those of its components, T and V, namely ∥vⱼ∥ and ∥wⱼ∥ according to Equations (29) and (30), respectively. Similarly, yⱼ⁽ⁱ⁾ is replaced by the corresponding coefficients of the univariate integrals obtained from A^{(m,s)}R^{(s)} and B^{(m,s)}R^{(s)} in Equation (32).

Both Taylor expansion errors in the determination of the univariate intermediate operator definition error are modified for the split operator embodiments.

Due to the absence of the product conversion step, the number of exponentials m grows significantly. For example, order 4 CFQM operators are available with only mₛ=12 exponentials, and order 6 CFQM operators are available with mₛ=20 exponentials. For clarity, the number of exponentials in this case is denoted with mₛ in the numerical results described herein to highlight that its increased value is due to using the split operator approach. Additionally, the norm c and c̅ are used to refer to the upper bounds of the norm of individual components.

The two split-operator CFQM operators described herein are for order 4 and order 6, which may apply to certain spin models as well as electronic structure Hamiltonians decomposing to the kinetic and Coulomb potentials. Although CFQM of order 4 and 6 are described herein, it is understood that the split operator approach may be extended to any arbitrary order number. Further, although the analysis described herein is for a Hamiltonian with two fast-forwardable terms, it is understood that Equation (34) may be extended to any Hamiltonian with more fast-forwardable terms. The error bounds described herein may be similarly applied as such Hamiltonians only depend on the number of exponentials, the coefficients found above, and bounds to the norm of the Hamiltonian terms and their Taylor expansion coefficients.

### F. Multi-Product Formulas

In some embodiments, the quantum simulation of a time-dependent Hamiltonian may be further optimized by replacing the resulting product formula (i.e., those derived from Step 6 of Algorithm 1) with a multi-product formula. Such multi-product formulas, as described in “Hamiltonian Simulation Using Linear Combinations of Unitary Operations” by A. M. Childs and N. Wiebe, Quantum Information and Computation 12, 0901, arXiv: 1202.5822 (2012) [Childs paper], the entire contents of which are incorporated by reference herein for all purposes, are a linear combination of powers of product formulas U₂ₛ(H; h) presented in the Childs paper as:

$${U}_{2 s , k} ( H ; h ) = {\sum }_{j = 1}^{M} {a}_{j} {U}_{2 s}^{{k}_{j}} ( H ; \frac{h}{{k}_{j}} ) = {e}^{- ihH} + O ( {h}^{2 {s}^{′} + 1} ) , \qquad ( 35 )$$

where e^{-ihH} denotes the Hamiltonian evolution, and O(h^{2s′+1}) is the error for a segment of length h,

$${U}_{2 s} ( H ; \frac{h}{{k}_{j}} )$$

is the equivalent of the CFQN

$${2 s}_{} ( {\overline{U}}_{m}^{[ 2 s ]} ( \frac{h}{{k}_{j}} ) )$$

described herein, and M can be chosen to be equal to s′≥s in Equation (35). The parameters kⱼ and amplitudes aⱼ may be selected such that ∥\vec{k}∥=O(s′²log s′), while the success probability, O(∥\vec{a}∥₁⁻¹) with ∥\vec{a}∥₁=O(log s′), can be amplified to O(1) via oblivious amplitude amplification for example as described in “Simulating Hamiltonian dynamics with a truncated Taylor series” by D. W. Berry et al., Physical Review Letters, 114 (9), 090502 (2015), the entire contents of which are incorporated by reference herein for all purposes. Hence, the multi-product formulas approach may be able to exponentially reduce the error from O(h^{2s+1}) to O(h^{2s′+1}) at the cost of an increased multiplicative overhead of O(s′²poly log s′) over the cost of standard product formulas. In other words, multi-product formulas may achieve an exponential cost reduction in terms of target accuracy compared to the alternative of increasing the order of the product formula, where generally each two-order increase may increase the cost by an order of five times.

For embodiments where the multi-product method is applicable, the exact evolution of the Hamiltonian should be expandable as

$${[ {2 s}_{} ( {\overline{U}}_{m}^{[ 2 s ]} ( \frac{h}{{k}_{j}} ) ) ]}^{{k}_{j}} = {e}^{Ω ( h )} + \frac{{h}^{2 s + 1}}{{k}_{j}^{2 s}} {\tilde{E}}_{2 s + 1} ( h ) + \frac{{h}^{2 s + 3}}{{k}_{j}^{2 s + 2}} {\tilde{E}}_{2 s + 3} ( h ) + … , \qquad ( 36 )$$

where \tilde{E}₂ₛ₊ᵢ(h) represents arbitrary error operators. A sufficient condition for this is that

$${2 s}_{} ( {\overline{U}}_{m}^{[ 2 s ]} ( h ) ) = {e}^{Ω ( h ) + {h}^{2 s + 1} {E}_{2 s + 1} + {h}^{2 s + 3} {E}_{2 s + 3} + …} , \qquad ( 37 )$$

where E₂ₛ₊ᵢ represents the error operators that are constant functions of the time step h. The condition set out in Equation (37) can be conceptualized as requiring only odd terms in h to be missing from the exact expression of Ω(h). The same approach is followed in the truncation of the Magnus operator in Equations (6) to (8) where only odd terms appear in the expression due to the time anti-symmetry that was enforced: Ω(t₀, t₀+h)=−Ω(t₀+h, t₀). For the multi-product formula approach, the error operators are provided by the missing commutators of the Hamiltonian derivatives evaluated at

$${t}_{\frac{1}{2}}$$

that are the aⱼ operators. Thus, the multi-product approach may be applied when an operator exhibits the time anti-symmetric behavior described herein. Such time anti-symmetry is also enforced in the CFQM operators in part due to the condition that x_{m+1-i,j}=(−1)^{j+1}x_{i,j}; from Equation (14). This condition is also incorporated into the expression for Um as may be discerned from the following:

$$\begin{matrix}{\sum }_{j} {x}_{i , j} {α}_{j} = {\sum }_{jg} {y}_{i} , {T}_{g , j}^{( s )} {α}_{j} = {\sum }_{g} {y}_{i , g} {A}^{( g )} ( h ) \\ ‖ \\ {\sum }_{j} {( - 1 )}^{j + 1} {x}_{m + 1 - i , j} {α}_{j} = {\sum }_{jg} {{y}_{m + 1 - i , g} ( - 1 )}^{j + 1} {T}_{g , j}^{( s )} {α}_{j} \\ = {\sum }_{g} {{y}_{m + 1 - i , g} ( - 1 )}^{g} {A}^{( g )} ( h ) .\end{matrix} \qquad ( 38 )$$

The rightmost equality in Equation (38) may be justified as follows. Recall that

$${T}_{g , j}^{( s )} = \frac{1 - {( - 1 )}^{g + j}}{( g + j ) {2}^{g + j}} , \qquad ( 39 )$$

which will be different from 0 if and only if g+j=1 mod 2, or in other words, j+1=g mod 2. Thus, one may substitute the (−1)^{j+1} with a (−1)^{g}, obtaining that y_{i,g}=(−1)^{g}y_{m+1-i,g}. Further recall that A^{(g)}(h) is either odd or even functions of h if g is even or odd, respectively. As such, the inclusion of higher-order terms not included in the truncation of A^{(g)}(h) to order 2s respects the time anti-symmetry.

The quadrature operator will also adhere to the time anti-symmetry in Equation (14). The odd rows in the quadrature matrix Q^{(s,k)} in Equation (33), multiplied by A^{(k)} with even k, exhibit symmetric behavior for nodes symmetrically chosen around

$${t}_{\frac{1}{2}} .$$

Conversely, the even rows, corresponding to odd k, symmetrically change signs across

$${t}_{\frac{1}{2}}$$

due to the sign change in cₖ and the symmetry of weights wₖ across

$${t}_{\frac{1}{2}} .$$

Together with the symmetry in the product formulas, this indicates that the commutator-free Magnus product formulas presented herein enable use of the multi-product formula method as described in “Well-conditioned multi-product Hamiltonian simulation” by G. H. Low, V. Kliuchnikov, and N. Wiebe, arXiv preprint, arXiv: 1907.11679 (2019) [Low paper], the entire contents of which are incorporated by reference herein for all purposes.

In some embodiments, to determine the error, and thus derive the cost of multi-product formulas, a methodology similar to Theorem 2 from the Low paper is followed.

First, the error contributions of order greater or equal to O(h^{2s′+1}) in the product formula need to be bounded. The form of the error may be similar to those defined in Equations (20), (22), and (23) where the summation may begin from order O(h^{2s′+1}) instead of O(h^{2s+1}). The error bound determined for the product formula step in Subsection D needs to be modified. In some embodiments, the result from Lemma F.2 described in “Toward the first quantum simulation with quantum speedup” by A. M. Childs, D. Maslov, Y. Nam, N. J. Ross, and Y. Su, Proceedings of the National Academy of Sciences 115, 9456 (2018), the entire contents of which are incorporated by reference herein for all purposes, may be used. The lemma bounds the Taylor remainder of exp(λ) of order k by

$$‖ {ℛ}_{k} ( exp ( λ ) ) ‖ \leq \frac{{\vert λ \vert}^{k + 1}}{( k + 1 ) !} exp ( \vert λ \vert ) .$$

The Taylor remainder above may be used to compute the O(h^{2s′+1}) error of each exponential in each product formula [symbol] ₂ₛ(Ūₘ^{[2s]}(h)), so in the case of multi-product formulas λ is of the form λ=Σₖ₌₁^{s}z_{i,k}Aₖh. Equation (24) may then be leveraged to obtain the product formula error of O(h^{2s′+1}). All the error terms may be summed to obtain the O(h^{2s′+1}) error for the CFQM.

Second, the error bound determined from the first step is to be converted into an error bound for the multi-product formula. In some embodiments, Equation (24) may be used to bound the error of multiplying together kⱼ product formulas of time length h/kⱼ. Then, to account for the final linear combination of unitaries, each error bound is multiplied by its corresponding |aⱼ| and summed together. As stated above, the result is an upper bound to the multi-product formula error as a function of h, aⱼ, and kⱼ. This bound may be used to maximize h subject to the error target imposed.

### IV. Error Bound Derivation

### A. Taylor Remainder of the Magnus Operator

It follows from Subsection III.A that the goal is to analyze:

$${\sum }_{p = 2 s + 1}^{∞} ‖ {exp ( Ω ( h ) )}_{p} ‖ , \qquad ( 40 )$$

where exp(Ω(h))ₚ denotes the order O(h^{p}) expansion of exp(Ω(h)). The Taylor series of the Hamiltonian, A(t), and the corresponding Lie algebra basis αᵢ are defined in Equation (5).

The following Magnus operator expansion is used to determine the error bounds that stem from truncating the Taylor series to a given order:

$$Ω ( {t}_{0} , {t}_{0} + h ) = {\sum }_{n = 1}^{∞} {\int }_{{t}_{0}}^{{t}_{0} + h} {dt}_{n} ⋯ {\int }_{{t}_{0}}^{{t}_{0} + h} {dt}_{1} {L}_{n} ( {t}_{n} , … , {t}_{1} ) A ( {t}_{n} ) … A ( {t}_{1} ) , \qquad ( 41 )$$

$$where$$

$${L}_{n} ( {t}_{n} , … , {t}_{1} ) = \frac{{Θ}_{n} ! ( n - 1 - {Θ}_{n} ) !}{n !} {( - 1 )}^{n - 1 - {Θ}_{n}} , \qquad ( 42 )$$

with Θₙ=θ_{n-1,n-2}+ . . . +θ_{2,1}, where θ_{b,a} is a step function defined as 1 if t_{b}>tₐ and 0 otherwise. Consequently, the expression in Equation (42) may be bounded as:

$$\vert {L}_{n} ( {t}_{n} , … , {t}_{1} ) \vert \leq \frac{( n - 1 ) !}{n !} = \frac{1}{n} . \qquad ( 43 )$$

Then, the Magnus operator defined in Equation (41) is expanded:

$$Ω ( {t}_{0} , {t}_{0} + h ) = {\sum }_{n = 1}^{∞} {\int }_{{t}_{0}}^{{t}_{0} + h} {dt}_{n} ⋯ {\int }_{{t}_{0}}^{{t}_{0} + h} {dt}_{1} {L}_{n} ( {t}_{n} , … , {t}_{1} ) A ( {t}_{n} ) … A ( {t}_{1} ) = {\sum }_{n = 1}^{∞} {\int }_{{t}_{0}}^{{t}_{0} + h} {dt}_{n} ⋯ {\int }_{{t}_{0}}^{{t}_{0} + h} {dt}_{1} {L}_{n} ( {t}_{n} , … , {t}_{1} ) ( {\sum }_{n = 1}^{∞} {{a}_{i} ( {t}_{n} - {t}_{\frac{1}{2}} )}^{i} ) … ( {\sum }_{n = 1}^{∞} {{a}_{i} ( {t}_{n} - {t}_{\frac{1}{2}} )}^{i} ) = {\sum }_{n = 1}^{∞} {\sum }_{p = 0}^{∞} {\sum }_{{p}_{1} + ⋯ + {p}_{n} = p} ( {a}_{{p}_{1}} \cdot … \cdot {a}_{{p}_{n}} ) {\int }_{{t}_{0}}^{{t}_{0} + h} {dt}_{n} ⋯ {\int }_{{t}_{0}}^{{t}_{0} + h} {dt}_{1} {L}_{n} ( {t}_{n} , … , {t}_{1} ) {( {t}_{1} - {t}_{\frac{1}{2}} )}^{{p}_{1}} \cdot … \cdot {( {t}_{n} - {t}_{\frac{1}{2}} )}^{{p}_{n}} . \qquad ( 44 )$$

Using the latter expression of Equation (44), all orders p may be bounded as follows:

$$‖ Ω ( {t}_{0} , {t}_{0} + h ) ‖ \leq {\sum }_{n = 1}^{∞} {\sum }_{k = 0}^{∞} {\sum }_{{p}_{1} + ⋯ + {p}_{n} = p} ( ‖ {a}_{{p}_{1}} \cdot … \cdot {a}_{{p}_{n}} ‖ \cdot {\int }_{{t}_{0}}^{{t}_{0} + h} {dt}_{n} ⋯ {\int }_{{t}_{0}}^{{t}_{0} + h} {dt}_{1} \vert {L}_{n} ( {t}_{n} , … , {t}_{1} ) \vert \cdot {\vert {t}_{1} - {t}_{\frac{1}{2}} \vert}^{{p}_{1}} \cdot … \cdot {\vert {t}_{n} - {t}_{\frac{1}{2}} \vert}^{{p}_{n}} ) \leq {\sum }_{n = 1}^{∞} \frac{1}{n} {\sum }_{p = 0}^{∞} {\sum }_{{p}_{1} + ⋯ + {p}_{n} = p} ‖ {a}_{{p}_{1}} \cdot … \cdot {a}_{{p}_{n}} ‖ ( {\int }_{{t}_{0}}^{{t}_{0} + h} {dt}_{n} {\vert {t}_{n} - {t}_{\frac{1}{2}} \vert}^{{p}_{n}} ) ⋯ ( {\int }_{{t}_{0}}^{{t}_{0} + h} {dt}_{1} {\vert {t}_{1} - {t}_{\frac{1}{2}} \vert}^{{p}_{1}} ) = {\sum }_{n = 1}^{∞} {\sum }_{k = 0}^{∞} {\sum }_{{p}_{1} + ⋯ + {p}_{n} = p} ‖ {a}_{{p}_{1}} \cdot … \cdot {a}_{{p}_{n}} ‖ ( \frac{2 {( \frac{h}{2} )}^{{p}_{1} + 1}}{{p}_{n} + 1} ) ⋯ ( \frac{2 {( \frac{h}{2} )}^{{p}_{1} + 1}}{{p}_{n} + 1} ) = {\sum }_{n = 1}^{∞} {\sum }_{k = 0}^{∞} \frac{{2}^{n} {( \frac{h}{2} )}^{p + n}}{n} {\sum }_{{p}_{1} + ⋯ + {p}_{n} = p} ‖ \frac{{a}_{{p}_{n}}}{{p}_{n} + 1} ‖ ⋯ ‖ \frac{{a}_{{p}_{1}}}{{p}_{1} + 1} ‖ . \qquad ( 45 )$$

Consequently, the Magnus operator expansion term ∥Ω(h)∥ may be bounded as:

$$‖ Ω ( h ) ‖ \leq {\sum }_{n = 1}^{∞} {\sum }_{p = 0}^{∞} \frac{{h}^{p + n}}{n {2}^{p + n}} {\sum }_{{p}_{1} + ⋯ + {p}_{n} = p} ‖ \frac{2 {a}_{{p}_{n}}}{{p}_{n} + 1} ‖ ⋯ ‖ \frac{2 {a}_{{p}_{1}}}{{p}_{1} + 1} ‖ , \qquad ( 46 )$$

where p₁, . . . , Pₙ∈N.

The parameter p is then recast as jᵢ=pᵢ+1, and parameter k is defined as k=p+n.

Then, the exponential of the Magnus operator may be bound as:

$$‖ exp ( Ω ( h ) ) ‖ \leq {\sum }_{z = 1}^{∞} \frac{1}{z !} {( {\sum }_{n = 1}^{∞} {\sum }_{k = n}^{∞} \frac{{h}^{k}}{n {2}^{k}} {\sum }_{{j}_{1} + ⋯ + {j}_{n} = k} ‖ \frac{2 {a}_{{j}_{n} - 1}}{{j}_{n}} ‖ ⋯ ‖ \frac{2 {a}_{{j}_{1} - 1}}{{j}_{1}} ‖ )}^{z} = {\sum }_{z = 1}^{∞} \frac{1}{z !} {\sum }_{{n}_{l} = 1}^{∞} {\sum }_{{k}_{l} = {n}_{l}}^{∞} \frac{{h}^{{k}_{l}}}{{n}_{l} {2}^{{k}_{l}}} {\sum }_{{j}_{{1}_{l}} + ⋯ + {j}_{{n}_{l}} = {k}_{l}} ‖ \frac{2 {a}_{{j}_{{n}_{l}} - 1}}{{j}_{{n}_{l}}} ‖ ⋯ ‖ \frac{2 {a}_{{j}_{{1}_{l}} - 1}}{{j}_{{1}_{l}}} ‖ = {\sum }_{p = 0}^{∞} {( \frac{h}{2} )}^{p} {\sum }_{z = 1}^{∞} \frac{1}{z !} {\sum }_{{n}_{1} , … , {n}_{z} = 1}^{∞} {\sum }_{{\sum }_{i = 1}^{z} {k}_{i} = p} {\prod }_{l = 1}^{z} \frac{1}{{n}_{l}} {\sum }_{{j}_{{1}_{l}} + ⋯ + {j}_{{n}_{l}} = {k}_{l}} ‖ \frac{2 {a}_{{j}_{{n}_{l}} - 1}}{{j}_{{n}_{l}}} ‖ ⋯ ‖ \frac{2 {a}_{{j}_{{1}_{l}} - 1}}{{j}_{{1}_{l}}} ‖ . \qquad ( 47 )$$

Then, each coefficient in the Taylor series of the Hamiltonian is bounded as ∥aⱼ∥≤c, and denote [symbol] (p) as the compositions of p, and [symbol] ^{z}(p) as the compositions of dimension z. When the last summation is expressed as a sum over jₗ∈ [symbol] ⁿ^{ₗ}(kₗ), it may be discerned that as jᵢ=pᵢ+1>0, the condition kᵢ≥nᵢ becomes redundant. Hence, one may further sum over all the nₗ to derive j∈ [symbol] (kₗ).

Thus, Equation (47) can be rewritten as:

$$‖ exp ( Ω ( h ) ) ‖ = {\sum }_{p = 2 s + 1}^{∞} {( \frac{h}{2} )}^{p} {\sum }_{z = 0}^{∞} \frac{1}{z !} {\prod }_{l = 1}^{z} \frac{1}{dim {j}_{l}} {\prod }_{{ℓ}_{l} = 1}^{dim {j}_{l}} \frac{2 ‖ {a}_{{j}_{{n}_{l}} - 1} ‖}{{j}_{{ℓ}_{l}}} \leq {\sum }_{p = 0}^{∞} {( \frac{h}{2} )}^{p} {\sum }_{z = 0}^{∞} \frac{1}{z !} {\prod }_{l = 1}^{z} \frac{{( 2 c )}^{dim {j}_{l}}}{dim {j}_{l}} {\prod }_{{ℓ}_{l} = 1}^{dim {j}_{l}} = {\sum }_{p = 0}^{∞} {( \frac{h}{2} )}^{p} \frac{1}{( dim k ) !} {\prod }_{l = 1}^{dim k} \frac{{( 2 c )}^{dim {j}_{l}}}{dim {j}_{l}} {\prod }_{{ℓ}_{l} = 1}^{dim {j}_{l}} \frac{1}{{j}_{{ℓ}_{l}}} . \qquad ( 48 )$$

The error that stems from the truncation of the remainder Taylor series expansion of the Magnus operator may then be bound as:

$${\sum }_{p = 2 s + 1}^{∞} ‖ {exp ( Ω )}_{p} ‖ \leq {\sum }_{p = 2 s + 1}^{∞} {( \frac{h}{2} )}^{p} \frac{1}{( dim k ) !} {\prod }_{l = 1}^{dim k} \frac{2 {( c )}^{dim {j}_{l}}}{dim {j}_{l}} {\prod }_{{ℓ}_{l} = 1}^{dim {j}_{l}} \frac{1}{{j}_{{ℓ}_{l}}} , \qquad ( 49 )$$

as presented earlier in Equation (20).

### B. Taylor Remainder of the Quasi-Magnus Operator

It follows from Subsection III.B that the goal is to analyze:

$${\sum }_{p = 2 s + 1}^{∞} ‖ {\tilde{U}}_{m , p}^{[ 2 s ]} ‖ . \qquad ( 50 )$$

As described herein, the CFQM operator Ũₘ^{[2s]} identically matches the Magnus operator up to order O(h^{2s+1}). To determine the error bound for the truncation of the remainder terms of the Taylor series of the CFQM, the operator is expanded:

$${\tilde{U}}_{m}^{[ 2 s ]} = {\prod }_{i = 1}^{m} exp ( {\sum }_{g = 0}^{s - 1} {y}_{i , g} {A}^{( g )} ( h ) ) = {\prod }_{i = 1}^{m} ( {\sum }_{k = 0}^{∞} \frac{{( {\sum }_{g = 0}^{s - 1} {y}_{i , g} {A}^{( g )} ( h ) )}^{k}}{k !} ) . \qquad ( 51 )$$

Recall that

$${A}^{( g )} ( h ) = {\sum }_{j = 1}^{∞} \frac{1 - {( - 1 )}^{g + j}}{( g + j ) {2}^{g + j}} {α}_{j}$$

and the term

$${{α}_{j} = \frac{1}{( j - 1 ) !} \frac{{d}^{j - 1} A}{{dt}^{j - 1}} \vert}_{t = {t}_{\frac{1}{2}}} {h}^{j}$$

contains a factor of h^{j}. To convert the product of exponentials into a sum in Equation (51), one may rewrite:

$${\sum }_{g = 0}^{s - 1} {y}_{i , g} {A}^{( g )} ( h ) = {\sum }_{g = 0}^{s - 1} {y}_{i , g} {\sum }_{j = 1}^{∞} \frac{1 - {( - 1 )}^{g + j}}{( g + j ) {2}^{g + j}} {α}_{j} = {\sum }_{j = 1}^{∞} {\sum }_{g = 0}^{s - 1} {y}_{i , g} \frac{1 - {( - 1 )}^{g + j}}{( g + j ) {2}^{g + j}} {α}_{j} . \qquad ( 52 )$$

Define parameter x̅_{i,j} as:

$${\overline{x}}_{i , j} := {\sum }_{g = 0}^{s - 1} {y}_{i , g} \frac{1 - {( - 1 )}^{g + j}}{( g + j ) {2}^{g + j}} , \qquad ( 53 )$$

which is an extension of x_{i,j} for values of j>s. Then, the summation in Equation (52) may be expressed as:

$${\sum }_{g = 0}^{s - 1} {y}_{i , g} {A}^{( g )} ( h ) = {\sum }_{j = 1}^{∞} {\overline{x}}_{i , j} {α}_{j} . \qquad ( 54 )$$

It follows that

$${( {\sum }_{g = 0}^{s - 1} {y}_{i , g} {A}^{( g )} ( h ) )}^{k} = {( {\sum }_{j = 1}^{∞} {\overline{x}}_{i , j} {α}_{j} )}^{k} = {\sum }_{{j}_{1} , … , {j}_{k} ∈ ( {ℤ}^{+} )} {\prod }_{l ∈ \{ 1 , … , k \}} {\overline{x}}_{i , {j}_{l}} {α}_{{j}_{l}} . \qquad ( 55 )$$

Substituting Equation (55) back into Equation (51), the CFQM operator may be expressed as:

$${\tilde{U}}_{m}^{{}_{[ 2 s ]}} = {\prod }_{i = 1}^{m} exp ( {\sum }_{g = 0}^{s - 1} {y}_{i , g} {A}^{( g )} ( h ) ) = {\prod }_{i = 1}^{m} ( {\sum }_{k = 0}^{∞} \frac{{( {\sum }_{g = 0}^{s - 1} {y}_{i , g} {A}^{( g )} ( h ) )}^{k}}{k !} ) = {\prod }_{i = 1}^{m} ( {\sum }_{k = 0}^{∞} \frac{1}{k !} {\sum }_{{j}_{1} , … , {j}_{k} ∈ {( {ℤ}^{+} )}^{k}} {\prod }_{l ∈ \{ 1 , … , k \}} {\overline{x}}_{i , {j}_{l}} {α}_{{j}_{l}} ) = {\sum }_{{k}_{1} , … , {k}_{m} = 0}^{∞} \frac{1}{{k}_{1} ! … {k}_{m} !} {\sum }_{\begin{matrix}{j}_{1 , 1} , … , {j}_{1 , {k}_{1}} ∈ {( {ℤ}^{+} )}^{{k}_{1}} \\ … \\ {j}_{m , 1} , … , {j}_{m , {k}_{m}} ∈ {( {ℤ}^{+} )}^{{k}_{m}}\end{matrix}} {\prod }_{i ∈ \{ 1 , … , m \}} {\prod }_{{l}_{i} ∈ \{ 1 , … , {k}_{i} \}} {\overline{x}}_{i , {j}_{{t}_{i}}} {α}_{{j}_{{l}_{i}}} . \qquad ( 56 )$$

Assuming the norm of the operator and its Taylor series coefficients are bounded, then one may also assume that ∥x̅_{i,j}_{ₗ}αⱼ_{ₗ}∥=∥x̅_{i,j}_{ₗ}αⱼ_{ₗ}₋₁∥h^{j}≤c̅^{j}^{ₗ}.

Thus, the CFQM operator may be bounded as:

$$‖ {\tilde{U}}_{m}^{[ 2 s ]} ‖ \leq {\sum }_{{k}_{1} , … , {k}_{m} = 0}^{∞} \frac{1}{{k}_{1} ! … {k}_{m} !} {\sum }_{{{j}_{1 , 1} , … , {j}_{1 , {k}_{1}} ∈ {( {ℤ}^{+} )}^{{k}_{1}}}_{{…}_{{j}_{m , 1} , … , {j}_{m , {k}_{m}} ∈ {( {ℤ}^{+} )}^{{k}_{m}}}}} {\prod }_{i ∈ \{ 1 , … , m \}} {\prod }_{{l}_{i} ∈ \{ 1 , … , {k}_{i} \}} ‖ {\overline{x}}_{i , {j}_{{l}_{i}}} {α}_{{j}_{{l}_{i}}} ‖ \leq {\sum }_{{k}_{1} , … , {k}_{m} = 0}^{∞} \frac{1}{{k}_{1} ! … {k}_{m} !} {\sum }_{{{j}_{1 , 1} , … , {j}_{1 , {k}_{1}} ∈ {( {ℤ}^{+} )}^{{k}_{1}}}_{{…}_{{j}_{m , 1} , … , {j}_{m , {k}_{m}} ∈ {( {ℤ}^{+} )}^{{k}_{m}}}}} {\prod }_{i ∈ \{ 1 , … , m \}} {\overline{c}}^{{k}_{i}} {h}^{{\sum }_{{l}_{i} ∈ \{ 1 , … , {k}_{i} \}} {j}_{{l}_{i}}} = {\sum }_{{k}_{1} , … , {k}_{m} = 0}^{∞} {\sum }_{{{j}_{1 , 1} , … , {j}_{1 , {k}_{1}} ∈ {( {ℤ}^{+} )}^{{k}_{1}}}_{{…}_{{j}_{m , 1} , … , {j}_{m , {k}_{m}} ∈ {( {ℤ}^{+} )}^{{k}_{m}}}}} \frac{{\overline{c}}^{{k}_{1}} … {\overline{c}}^{{k}_{m}}}{{k}_{1} ! … {k}_{m} !} {h}^{{\sum }_{i = 1}^{m} {\sum }_{{l}_{i} ∈ \{ 1 , … , {k}_{i} \}} {j}_{{l}_{i}}} . \qquad ( 57 )$$

The terms are then grouped by the exponent of h. Let [symbol] (p) denote the combinations (e.g., partitions of p where order matters). Let w=[j] be an element of [symbol] (p) of size dim w. Then, there are m^{dim w} ways of allocating the terms of w between k₁, . . . , kₘ. Consequently, the terms of Ũₘ^{[2s]} of order O(h^{p}), denoted Ũ_{m,p}^{[2s]}, may be bound by

$$‖ {\tilde{U}}_{m , p}^{[ 2 s ]} ‖ \leq {h}^{p} {\sum }_{{k}_{i} : {\sum }_{i = 1}^{m} {k}_{i} = dim w} \frac{{\overline{c}}^{{k}_{1}} … {\overline{c}}^{{k}_{m}}}{{k}_{1} ! … {k}_{m} !} = {h}^{p} {\sum }_{w ∈ 𝒞 ( p )} {\overline{c}}^{dim w} {\sum }_{{k}_{i} : {\sum }_{i = 1}^{m} {k}_{i} = dim w} \frac{1}{{k}_{1} ! … {k}_{m} !} , \qquad ( 58 )$$

where the expression kᵢ: Σᵢ₌₁^{m}kᵢ=dim w can also be understood as the weak integer compositions of dim w. Overall, the quasi-Magnus Taylor error may be bound as:

$${\sum }_{p = 2 s + 1}^{∞} ‖ {\tilde{U}}_{m , p}^{[ 2 s ]} ‖ \leq {\sum }_{p = 2 s + 1}^{∞} {h}^{p} {\sum }_{{k}_{i} : {\sum }_{i = 1}^{m} {k}_{i} = dim w} \frac{{\overline{c}}^{{k}_{1}} … {\overline{c}}^{{k}_{m}}}{{k}_{1} ! … {k}_{m} !} . \qquad ( 59 )$$

### C. Quadrature Error

It follows from Subsection III.C that the goal is to analyze:

$$‖ {\tilde{U}}_{m}^{[ 2 s ]} - {\overline{U}}_{m}^{[ 2 s ]} ‖ = ‖ {\prod }_{i = 1}^{m} exp ( {\sum }_{g = 0}^{s - 1} {y}_{i g} {A}^{( g )} ( h ) ) - {\prod }_{i = 1}^{m} exp ( {\sum }_{k = 1}^{s} {z}_{i , k} {A}_{k} h ) ‖ . \qquad ( 60 )$$

For brevity and clarity, let X₁, . . . , Xₘ and Y₁, . . . , Yₘ denote the two sets of exponents in Equation (60). It then follows that

$${e}^{{X}_{1}} … {e}^{{X}_{m}} = ( {e}^{{Y}_{1}} + {e}^{{X}_{1}} - {e}^{{Y}_{1}} ) {e}^{{X}_{2}} … {e}^{{X}_{m}} = {e}^{{Y}_{1}} {e}^{{X}_{2}} … {e}^{{X}_{m}} + ( {e}^{{X}_{1}} - {e}^{{Y}_{1}} ) {e}^{{X}_{2}} … {e}^{{X}_{m}} = {e}^{{Y}_{1}} {e}^{{Y}_{2}} … {e}^{{X}_{m}} + ( {e}^{{X}_{1}} - {e}^{{Y}_{1}} ) {e}^{{X}_{2}} … {e}^{{X}_{m}} + {e}^{{Y}_{1}} ( {e}^{{X}_{2}} - {e}^{{Y}_{2}} ) {e}^{{X}_{2}} … {e}^{{X}_{m}} … = {e}^{{Y}_{1}} … {e}^{{Y}_{m}} + {\sum }_{j = 1}^{m} {e}^{{Y}_{1}} … {e}^{{Y}_{j - 1}} ( {e}^{{X}_{j}} - {e}^{{Y}_{j}} ) {e}^{{X}_{j + 1}} … {e}^{{X}_{m}} . \qquad ( 61 )$$

Since all operators e^{X}^{ᵢ} and e^{Y}^{ᵢ} are unitary, the following bound may be established:

$$‖ {e}^{{X}_{1}} … {e}^{{X}_{m}} - {e}^{{Y}_{1}} … {e}^{{Y}_{m}} ‖ \leq {\sum }_{j = 1}^{m} ‖ {e}^{{Y}_{1}} ‖ … ‖ {e}^{{Y}_{j - 1}} ‖ \cdot ‖ {e}^{{X}_{j}} - {e}^{{Y}_{j}} ‖ \cdot ‖ {e}^{{X}_{j + 1}} ‖ … ‖ {e}^{{X}_{m}} ‖ = {\sum }_{j = 1}^{m} ‖ {e}^{{X}_{j}} - {e}^{{Y}_{j}} ‖ . \qquad ( 62 )$$

One may then apply the following corollary which appears as Corollary A.5 in “Theory of Trotter error with commutator scaling” by A. M. Childs, Y. Su, M. C. Tran, N. Wiebe, and S. Zhu, Physical Review X 11, 011020 (2021), the entire contents of which are incorporated by reference herein for all purposes, which states: given [symbol] and [symbol] , two anti-Hermitian continuous operator-valued functions defined on [symbol] ,

$$‖ 𝒯 exp ( {\int }_{{t}_{1}}^{{t}_{2}} d τ ℋ ( τ ) ) - 𝒯 exp ( {\int }_{{t}_{1}}^{{t}_{2}} d τ 𝒢 ( τ ) ) ‖ \leq \vert {\int }_{{t}_{1}}^{{t}_{2}} d τ ‖ ℋ ( τ ) - 𝒢 ( τ ) ‖ \vert . \qquad ( 63 )$$

A consequence of the corollary may be that the bound in Equation (62) may be expressed as:

$$‖ {e}^{{X}_{1}} … {e}^{{X}_{m}} - {e}^{{Y}_{1}} … {e}^{{Y}_{m}} ‖ \leq {\sum }_{j = 1}^{m} ‖ {X}_{j} - {Y}_{j} ‖ . \qquad ( 64 )$$

For an individual exponential term Xᵢ=Σ_{g=0}^{s-1}y_{i,g}A^{(g)}(h), the error from approximating the univariate integral A^{(g)} with quadrature is given by Rₙ in:

$${\int }_{a}^{b} f ( x ) dx = {\sum }_{k = 1}^{n} {w}_{k} f ( {c}_{k} ) + {R}_{n ,} \qquad ( 65 )$$

which can be bounded using the expression taken from “Numerical methods and software” by D. Kahaner, C. Moler, and S. Nash, Prentice-Hall, Inc. (1989), the entire contents of which are incorporated by reference herein for all purposes:

$${R}_{n} = \frac{{( b - a )}^{2 n + 1} {( n ! )}^{4}}{( 2 n + 1 ) {( ( 2 n ) ! )}^{3}} {f}^{( 2 n )} ( ξ ) , a < ξ < b . \qquad ( 66 )$$

Consequently, the error from approximating the univariate integral basis expression in Equation (9) with an n-point Gauss-Legendre quadrature for example is:

$$‖ {R}_{n} ( {A}^{( g )} ) ( h ) ‖ = \frac{{{h}^{2 n + 1} ( n ! )}^{4}}{( 2 n + 1 ) {( ( 2 n ) ! )}^{3}} ‖ \frac{{d}^{2 n}}{d {t}^{2 n}} \frac{1}{{h}^{g}} {\sum }_{j = 0}^{∞} {a}_{j} {t}^{g + j} {\vert}_{t = ξ} ‖ = \frac{{{h}^{2 n + 1} ( n ! )}^{4}}{( 2 n + 1 ) {( ( 2 n ) ! )}^{3}} \frac{1}{{h}^{g}} ‖ {\sum }_{j = 0}^{∞} {a}_{j} \frac{{d}^{2 n}}{d {t}^{2 n}} {t}^{g + j} {\vert}_{t = ξ} ‖ = \frac{{{h}^{2 n + 1} ( n ! )}^{4}}{( 2 n + 1 ) {( ( 2 n ) ! )}^{3}} \frac{1}{{h}^{g}} v ‖ {\sum }_{j = 2 n - g}^{∞} {a}_{j} \frac{( g + j ) !}{( g + j - 2 n ) !} {t}^{g + j - 2 n} {\vert}_{t = ξ} ‖ = \frac{{{h}^{2 n + 1} ( n ! )}^{4}}{( 2 n + 1 ) {( ( 2 n ) ! )}^{3}} \frac{1}{{h}^{g}} ‖ {\sum }_{j = 0}^{∞} {a}_{j} \frac{( j + 2 n ) !}{j !} {t}^{j} {\vert}_{t = ξ} ‖ \leq \frac{{{h}^{2 n + 1} ( n ! )}^{4}}{( 2 n + 1 ) {( ( 2 n ) ! )}^{3}} \frac{1}{{h}^{g}} {\sum }_{j = 0}^{∞} \frac{( j + 2 n ) !}{j !} \frac{{h}^{j}}{{2}^{j}} ‖ {a}_{j} ‖ . \qquad ( 67 )$$

Since the integral limits a and b are

$$\pm \frac{h}{2}$$

in the second equality in Equation (9),

$$\vert ξ \vert < \frac{h}{2}$$

and the last inequality in Equation (67) are justified. This expression may be used to bound the quadrature error as:

$$‖ {\tilde{U}}_{m}^{[ 2 s ]} - {\overline{U}}_{m}^{[ 2 s ]} ‖ \leq {\sum }_{i = 1}^{m} {\sum }_{g = 0}^{s - 1} ‖ {y}_{i , g} {R}_{s} ( {A}^{( g )} ) ‖ . \qquad ( 68 )$$

### V. Numerical Results

By way of non-limiting examples, the performance of some embodiments of the CFQM method described herein is analyzed using the time-dependent Heisenberg model:

$$- iA ( t ) = \frac{1}{4 n} {\sum }_{i = 1}^{n - 1} {\vec{σ}}_{i} {\vec{σ}}_{i + 1} + \frac{1}{4 n} {\sum }_{i = 1}^{n} cos ( {ϕ}_{i} + {ω}_{i} t ) {σ}_{i}^{z} . \qquad ( 69 )$$

The factor of

$$\frac{4}{4 n}$$

is introduced to ensure ∥A(t)∥≤1 for a simplified analysis. Additionally, it is assumed that (ωᵢ, ϕᵢ) are arbitrarily chosen such that

$$\frac{J}{j !} ‖ \frac{{d}^{j} A ( t )}{{dt}^{j}} ‖ \leq c \leq 1 , ∀ j ∈ ℕ . \qquad ( 70 )$$

The implementation costs of four CFQMs of order 4 (with m=2 or m=3 exponentials) and order 6 (with m=5 and m=6 exponentials) are analyzed, as well as the implementation cost of two “split-operator” CFQMs that avoid the last product formula decomposition step.

### A. Time-dependent Heisenberg Hamiltonians

First, an expression for the product formula error term is determined. To compute the simulation error, a Trotter-Suzuki product formula decomposition is applied to each exponential in Ūₘ^{[2s]} per Equation (16). The product formula error of such an approximation may be calculated utilizing, at least in part, the disclosure from “Nearly optimal lattice simulation by product formulas” by A. M. Childs and Y. Su, Physical Review Letters 123, 050503 (2019), the entire contents of which are incorporated by reference herein for all purposes. Each exponent Σₖ₌₁^{s}zᵢₖAₖh is decomposed into two fast-forwardable terms −iBh and −iCh, the Hamiltonian simulation cost of which depends only logarithmically on the simulation time. For each Aₖ, the even and odd indexed terms in the Hamiltonian are grouped as:

$${H}_{k , odd} = \frac{1}{4 n} {\sum }_{k = 1}^{⌊ \frac{n}{2} ⌋} ( {( \vec{σ} )}_{2 k - 1} {\vec{σ}}_{2 k} + cos ( {ϕ}_{2 k - 1} + {ω}_{2 k - 1} {t}_{k} ) {σ}_{2 k - 1}^{z} ) , \qquad ( 71 )$$

$${H}_{k , even} = \frac{1}{4 n} {\sum }_{k = 1}^{⌈ \frac{n}{2} ⌉ - 1} ( {( \vec{σ} )}_{2 k} {\vec{σ}}_{2 k + 1} + cos ( {ϕ}_{2 k} + {ω}_{2 k} {t}_{k} ) {σ}_{2 k}^{z} ) , \qquad ( 72 )$$

where

$${t}_{k} = {t}_{0} + {c}_{k} \frac{h}{2} .$$

Thus, for each exponential index by i, B:=Σₖ₌₁^{s}zᵢₖH_{k,odd} and C:=Σₖ₌₁^{s}zᵢₖH_{k,even}. Let H=B+C be a time-independent Hamiltonian, with B and C being Hermitian operators. Let S be a product formula, which has the form:

$$( t ) := ( {e}^{it {ξ}_{ς} C} {e}^{- it {β}_{ς} B} … ( {e}^{- it {ξ}_{1} C} {e}^{- it {β}_{1} B} ) , \qquad ( 73 )$$

where the parameter [symbol] denotes the number of stages. Let u be an upper bound to the coefficients such that:

$$max \{ \vert {ξ}_{1} \vert , … , \vert {ξ}_{ς} \vert , \vert {β}_{1} \vert , … , \vert {β}_{ς} \vert \} \leq u . \qquad ( 74 )$$

The product formula [symbol] is said to have an order p if [symbol] (t)=e^{-iHt}+O(t^{p+1}) and it is denoted as [symbol] ₚ(t). Consequently, the 2s-th order Trotter-Suzuki product formula [symbol] ₂ₛ(t) is an ( [symbol] , p, u)-formula with [symbol] =2·55^{s-1}, p=2s, and u=1.

According to “Nearly optimal lattice simulation by product formulas” by A. M. Childs and Yuan Su, Physical Review Letters 123, 050503 (2019), the entire contents of which are incorporated by reference herein for all purposes, the error of simulating an unnormalized Heisenberg Hamiltonian scales, using the Trotter-Suzuki product formula, as:

$$\begin{matrix}‖ {p}_{} ( t ) - {e}^{- iHt} ‖ \\ \begin{matrix}\leq {\sum }_{k = 1}^{ς} {n ( 2 k - 1 )}^{p} ( ku ) {( 2 u )}^{p} {( 2 k - 2 )}^{p} \frac{{t}^{p + 1}}{( p + 1 ) !} \\ + {\sum }_{k = 1}^{ς} {n ( 2 k + 1 )}^{p} ( ku ) {( 2 u )}^{p} {( 2 k )}^{p} \frac{{t}^{p + 1}}{( p + 1 ) !} .\end{matrix}\end{matrix} \qquad ( 75 )$$

Since a normalized Heisenberg model is described here, to use Equation (75), the factor of (4n)⁻¹ is absorbed into t. Similarly, the prefactor Σₖ₌₁^{s}|z_{i,k}| is also incorporated into t for each of the i=1, . . . , m exponentials. Thus, by defining

$${Z}_{i} = \frac{{\sum }_{k = 1}^{s} \vert {z}_{i , k} \vert}{4 n}$$

and substituting the expression into the remaining parameters of the 2s-th order Trotter-Suzuki formula, one derives:

$$\begin{matrix}‖ {2 s}_{} ( h ) - {e}^{{\sum }_{k = 1}^{s} {z}_{i , k} {A}_{k}} ‖ \\ \begin{matrix}\leq {\sum }_{k = 1}^{2 \cdot {5}^{s - 1}} {n ( 2 k - 1 )}^{2 s} {k ( 4 k - 4 )}^{2 s} \frac{{( {Z}_{i} h )}^{2 s + 1}}{( 2 s + 1 ) !} \\ + {\sum }_{k = 1}^{2 \cdot {5}^{s - 1}} {n ( 2 k - 1 )}^{2 s} {k ( 4 k )}^{2 s} \frac{{( {Z}_{i} h )}^{2 s + 1}}{( 2 s + 1 ) !} .\end{matrix}\end{matrix} \qquad ( 76 )$$

Equation (76), in combination with Equation (24), permits the determination of the product formula error in this embodiment.

### B. Comparison With the Suzuki Method

There are a number of known techniques in the quantum algorithms literature to simulate time-dependent Hamiltonians: the Suzuki method as described in “Higher order decompositions of ordered operator exponentials” by N. Wiebe, D. Berry, P. Høyer, and B. C. Sanders, Journal of Physics A: Mathematical and Theoretical 43, 065203 (2010), the entire contents of which are incorporated by reference herein for all purposes, the continuous qDRIFT technique as described in “Time-dependent Hamiltonian simulation with L¹-norm scaling” by D. W. Berry, A. M. Childs, Y. Su, X. Wang, and N. Wiebe, Quantum 4, 254 (2020), the entire contents of which are incorporated by reference herein for all purposes, and the Dyson series method as described in “Hamiltonian simulation in the interaction picture” by H. Low and N. Wiebe, arXiv preprint arXiv: 1805.00675 (2018), the entire contents of which are incorporated by reference herein for all purposes. Additionally, the time evolution may also be approximated by using the Hamiltonian evaluated at the midpoint of each segment, which is known as the exponential midpoint method as described in “Propagators for the time-dependent Kohn-Sham equations: Multistep, Runge-Kutta, exponential Runge-Kutta, and commutator free Magnus methods” by A. Gomez Pueyo, M. A. Marques, A. Rubio, and A. Castro, Journal of Chemical Theory and Computation 14, 3040 (2018), the entire contents of which are incorporated by reference herein for all purposes.

Among the known methods, the Suzuki method is also product formula based, similar to the CFQM method described herein. Thus, the performance of the CFQM method described herein is compared to that of the Suzuki method using three key variables: the total simulation time T, the target error E, and the number of spins n. It is noted that the Hamiltonian under consideration in all comparisons described herein refer to the time-dependent Heisenberg Hamiltonian of equation (69) where n describes the size of the system (i.e., the number of qubits the Hamiltonian acts on).

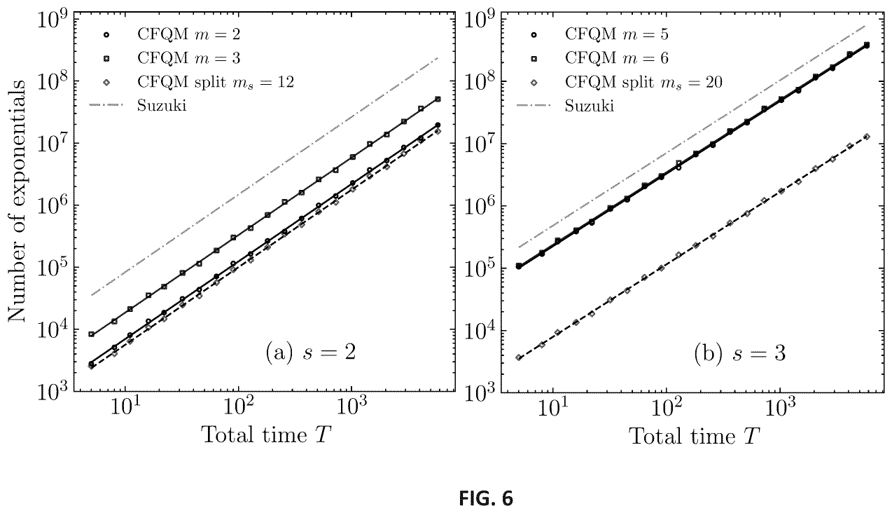

FIG. 6 illustrates the simulation time of three embodiment CFQM operators and the Suzuki operator in terms of time T when simulating the time-dependent Heisenberg model of Equation (69) for n=128 and ε=10⁻³. The y-axis represents the number of fast-forwardable exponentials to be implemented, which is shown to increase as

$${T}^{1 + \frac{1}{2 S}}$$

for all cases. The left subgraph (a) illustrates the simulation results of 4th-order operators, and the right subgraph (b) illustrates the simulation results for 6th-order operators.

As may be discerned from FIG. 6, both the Suzuki and CFQM operators scale asymptotically as

$$O ( {T}^{1 + \frac{1}{2 S}} ) .$$

However, the CFQM operators display a lower constant multiplicative factor overhead, saving up to an order of magnitude of simulation time with respect to the Suzuki method as shown in subgraph (a). Similarly favorable results of CFQMs may be found in subgraph (b). FIG. 6 also shows better simulation performance of the split-operator CFQM in both cases, with slightly more improvement in the 6th-order case due, at least in part, to its better scaling.

The improvement in performance for the CFQM operators demonstrates that the method described herein may be advantageous in one or more aspects over the known methods in the area of performing simulations of time-dependent quantum systems in fault-tolerant quantum computers.

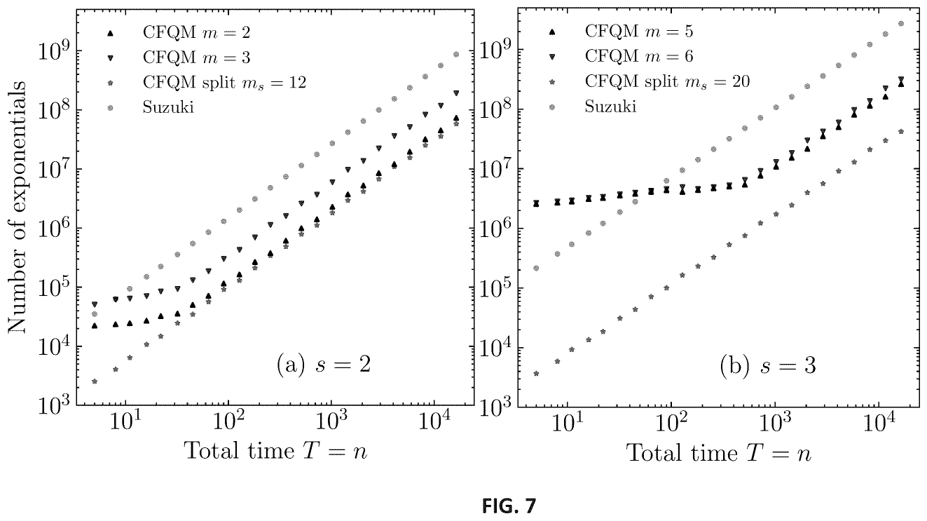

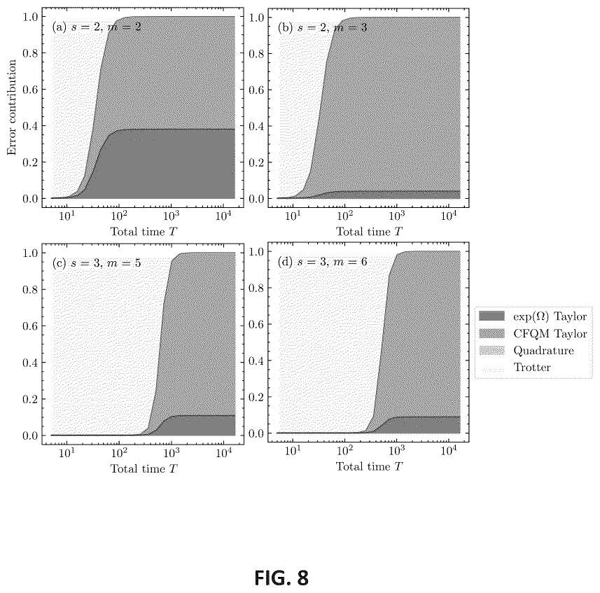

Subgraph (b) of FIG. 6 shows comparable simulation performance between the Suzuki operator and the two 6th-order non-split CFQM operators. This may be, at least in part, due to the product formula error, defined in Equation (76), which dominates in that ε and n regime. This may also be seen from FIG. 7, which illustrates the simulation cost comparisons of three embodiment CFQM operators and the Suzuki operator in terms of time T when simulating the time-dependent Heisenberg model of Equation (69) for n=T and ε=10⁻³, and FIG. 8, which illustrates the percentage of the contribution from each of the three error components identified in Section III to the overall simulation error in the non-split, or general case, CFQMs in the simulation shown in FIG. 7.

Specifically, academic articles have shown that Trotter-based product formula methods display an implementation cost that is almost linear in n for spin lattice Hamiltonians, while the available bounds for the Suzuki method and the Taylor series truncation error bounds of CFQM imply a superquadratic cost on the number of spins of an unnormalized Heisenberg Hamiltonian: one factor of n due to the increased norm value, and another Õ(n) due to the cost of implementing each exponential over n spins. This can be seen more clearly in FIG. 7, where spin n is chosen as n=T. Similar comparisons have been performed in academic literature, such as those described in Quantum algorithm for simulating real time evolution of lattice Hamiltonians by J. Haah, M. B. Hastings, R. Kothari, and G. H. Low, SIAM Journal on Computing 0, FOCS18 (2021). FIG. 8 illustrates the percentage of the contribution from each of the three error components identified in Section III to the overall simulation error in the non-split, or general case, CFQMs of FIG. 4. As can be discerned from FIG. 8, the general case, or non-split, CFQM operator exhibits two distinct regimes—a first regime where the product formula error is the predominant error term, and a second regime where the Taylor series truncation errors of the univariate intermediate integral definition error become the more predominant error term. As shown in FIG. 7, the first regime is characterized with a relatively flat implementation cost growth, consistent with the almost linear cost of product formula methods, such as the Trotter method, once it is taken into consideration that the cost of implementing each exponential is Õ(n).

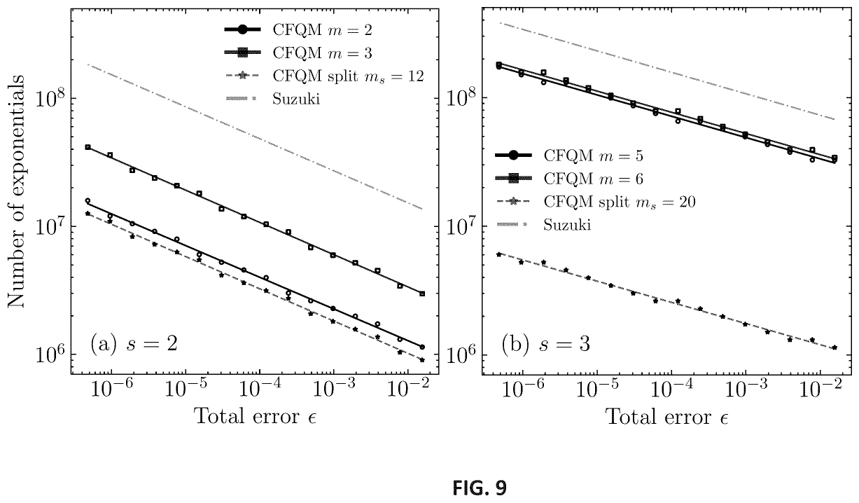

FIG. 9 illustrates the implementation cost scaling of the CFQM and Suzuki operators as a function of the target error ε. Plots are shown for (a) 4th-order operators, and (b) 6th-order operators. The number of spins is selected as n=128 and the total evolution time is chosen as T=1024. The y-axis indicates the number of fast-forwardable exponentials to be implemented, and in all cases, they increase as

$${ε}^{- \frac{1}{2 S}} .$$

As may be seen from FIG. 9, the CFQM operators' asymptotic behavior is

$$O ( {ϵ}^{- \frac{1}{2 S}} )$$

at fixed T=1024 and n=128. As shown, to achieve the same simulation error, the number of fast-forwardable exponentials implemented by the CFQM operators is less than that of the Suzuki operator. In other words, by implementing the same number of fast-forwardable exponentials, the Suzuki operator incurs a much larger error compared to the CFQM operators.

Although the present disclosure may describe methods and processes with steps in a certain order, one or more steps of the methods and processes may be omitted or altered as appropriate. One or more steps may take place in an order other than that in which they are described, as appropriate.

Although the present disclosure may be described, at least in part, in terms of methods, a person of ordinary skill in the art will understand that the present disclosure is also directed to the various components for performing at least some of the aspects and features of the described methods, be it by way of hardware components, software, or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, a USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices, and processes disclosed and shown herein may comprise a specific number of elements/components, the systems, devices, and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method of time-dependent quantum simulation comprising:
receiving, at a classical processor, a time-dependent Hamiltonian describing a quantum system, a target error, and a total simulation time T;
modeling a time evolution of the Hamiltonian with a Magnus operator based on a time step size h, the target error, and the total simulation time, the Magnus operator having one or more nested commutators and integrals;
approximating the Magnus operator with a commutator-free operator up to an order n;
performing error estimation between the commutator-free operator and the Magnus operator as a result of the approximation, the error estimation based at least in part on h; and
simulating, on a quantum processor, the dynamics of the quantum system by implementing the commutator-free operator via one or more quantum gates, and applying the one or more quantum gates to an initial state of the quantum system for the total simulation time in temporal increments of h, the step size h having a value such that a simulation error of the simulation is less than or equal to the target error.

2. The method of claim 1, wherein the modelling further includes:
constructing a Magnus operator ansatz;
decomposing the time-dependent Hamiltonian into a Taylor series expansion; and
substituting the Taylor series expansion into the Magnus operator ansatz to derive the Magnus operator.

3. The method of claim 1, wherein the approximating of the Magnus operator further includes:
converting the Magnus operator to an intermediate operator comprising a plurality of Lie algebra generators;
performing a change of basis on the intermediate operator from the plurality of Lie algebra generators to generate a univariate intermediate operator comprising one or more exponentials of univariate integrals;
generating a plurality of quadrature-based exponentials based on the one or more exponentials of univariate integrals by applying a quadrature rule; and
approximating the one or more quadrature-based exponentials as a product formula of order n, where the product formula is the commutator-free operator.

4. The method of claim 3, wherein the product formula approximating the quadrature-based exponentials is a Trotter-Suzuki product formula of order n.

5. The method of claim 1, wherein the error estimation includes:
minimizing a number of simulation steps T/h needed to simulate the time evolution of the Hamiltonian for the total simulation time using the target error as an upper bound of the simulation error.

6. The method of claim 1, wherein the error estimation includes determining an error bound for each of a univariate intermediate operator definition error and a quadrature error as a function of h.

7. The method of claim 6, wherein the error estimation includes determining an error bound for a product formula conversion error as a function of h.

8. The method of claim 6, wherein the determining of the error bound for the univariate intermediate operator definition error includes:
determining an error bound for a first series truncation error, the error bound for the first series truncation error including error terms of order higher than n in h, wherein the coefficient at each order includes sums over nested integer compositions, with an outermost term being compositions of the order, and is weighted by a fraction having a numerator that is a power of the upper bound to the norm of (1) the Hamiltonian and (2) coefficients of a Taylor series expansion of the Hamiltonian; and
determining an error bound for a second series truncation error, the error bound for the second series truncation error including error terms of order higher than n in h, wherein the coefficient at each order includes sums over weak integer compositions of the order and is weighted by a multinomial of the terms of the weak integer compositions and the upper bound to the norm of (1) the Hamiltonian and (2) the coefficients of the Taylor series expansion.

9. The method of claim 6, wherein the determining of the error bound for the quadrature error includes determining a distance between a plurality of quadrature-based exponentials and one or more exponentials of univariate integrals using a quadrature rule.

10. The method of claim 3, wherein the Hamiltonian is a sum of a plurality of self-commuting fast-forwardable Hermitian operators, including a time-independent kinetic operator and a time-dependent potential operator; and the quadrature-based exponentials are the commutator-free operator.

11. The method of claim 3, wherein the quadrature-based exponentials are approximated by a multi-product formula as a linear combination of powers of the commutator-free operator product formulas with fractions of h as a simulation step size.

12. The method of claim 1, wherein the simulation error includes an error bound for a multi-product formula conversion error as a function of h and the coefficients of the linear combination defining the multi-product formula.

13. A non-transitory, processor-readable medium storing instructions that, when executed by one or more processors, cause the one or more processors to:
receive, at a classical processor, a time-dependent Hamiltonian describing a quantum system, a target error, and a total simulation time T;
model a time evolution of the Hamiltonian with a Magnus operator based on a time step size h, the target error, and the total simulation time, the Magnus operator having one or more nested commutators and integrals;
approximate the Magnus operator with a commutator-free operator up to an order n;
perform error estimation between the commutator-free operator and the Magnus operator as a result of the approximation, the error estimation based at least in part on h; and
simulate, on a quantum processor, the dynamics of the quantum system by implementing the commutator-free operator via one or more quantum gates, and applying the one or more quantum gates to an initial state of the quantum system for the total simulation time in temporal increments of h, the step size h having a value such that a simulation error of the simulation is less than or equal to the target error.

14. The non-transitory, processor-readable medium of claim 13, wherein the instructions to model the time evolution include instructions to:
construct a Magnus operator ansatz;
decompose the time-dependent Hamiltonian into a Taylor series expansion; and
substitute the Taylor series expansion into the Magnus operator ansatz to derive the Magnus operator.

15. The non-transitory, processor-readable medium of claim 13, wherein the instructions to approximate the Magnus operator include instructions to:
convert the Magnus operator to an intermediate operator comprising a plurality of Lie algebra generators;
perform a change of basis on the intermediate operator from the plurality of Lie algebra generators to generate a univariate intermediate operator comprising one or more exponentials of univariate integrals;
generate a plurality of quadrature-based exponentials based on the one or more exponentials of univariate integrals by applying a quadrature rule; and
approximate the one or more quadrature-based exponentials as a product formula of order n, where the product formula is the commutator-free operator.

16. The non-transitory, processor-readable medium of claim 15, wherein the product formula approximating the quadrature-based exponentials is a Trotter-Suzuki product formula of order n.

17. The non-transitory, processor-readable medium of claim 13, wherein the instructions to perform the error estimation include instructions to:
minimize a number of simulation steps T/h needed to simulate the time evolution of the Hamiltonian for the total simulation time using the target error as an upper bound of the simulation error.

18. The non-transitory, processor-readable medium of claim 13, wherein the instructions to perform the error estimation include instructions to determine an error bound for each of a univariate intermediate operator definition error and a quadrature error as a function of h.

19. The non-transitory, processor-readable medium of claim 18, wherein the instructions to perform the error estimation include instructions to determine an error bound for a product formula conversion error as a function of h.

20. The non-transitory, processor-readable medium of claim 18, wherein the instructions to determine the error bound for the univariate intermediate operator definition error include instructions to:
determine an error bound for a first series truncation error, the error bound for the first series truncation error including error terms of order higher than n in h, wherein the coefficient at each order includes sums over nested integer compositions, with an outermost term being compositions of the order, and is weighted by a fraction having a numerator that is a power of the upper bound to the norm of (1) the Hamiltonian and (2) coefficients of a Taylor series expansion of the Hamiltonian; and
determine an error bound for a second series truncation error, the error bound for the second series truncation error including error terms of order higher than n in h, wherein the coefficient at each order includes sums over weak integer compositions of the order and is weighted by a multinomial of the terms of the weak integer compositions and the upper bound to the norm of (1) the Hamiltonian and (2) the coefficients of the Taylor series expansion.

21. The non-transitory, processor-readable medium of claim 18, wherein the instructions to determine the error bound for the quadrature error include instructions to determine a distance between a plurality of quadrature-based exponentials and one or more exponentials of univariate integrals using a quadrature rule.

22. The non-transitory, processor-readable medium of claim 15, wherein the Hamiltonian is a sum of a plurality of self-commuting fast-forwardable Hermitian operators, including a time-independent kinetic operator and a time-dependent potential operator; and the quadrature-based exponentials are the commutator-free operator.

23. The non-transitory, processor-readable medium of claim 15, wherein the quadrature-based exponentials are approximated by a multi-product formula as a linear combination of powers of the commutator-free operator product formulas with fractions of h as a simulation step size.

24. The non-transitory, processor-readable medium of claim 13, wherein the simulation error includes an error bound for a multi-product formula conversion error as a function of h and the coefficients of the linear combination defining the multi-product formula.
